(19) United States
(12) Patent Application Publication
(10) Pub. No.: US 2018/0346667 A1
(43) Pub. Date: Dec. 6, 2018

(54) PLANT BASED MATERIAL FOR INJECTION MOLDING

(71) Applicant: Carlsberg A/S, Copenhagen V (DK)

(72) Inventors: Renil Manat, Rødovre (DK); Steen Vesborg, Gentofte (DK); Hélène Rossignol, Copenhagen V (DK)

(21) Appl. No.: 15/778,144

(22) PCT Filed: Nov. 24, 2016
(86) PCT No.: PCT/EP2016/078688

§ 371 Date: May 22, 2018

(30) Foreign Application Priority Data
Nov. 24, 2015 (EP) 15196083.8

(51) Int. Cl. C08J 5/04; C08L 97/00; C08H 7/00; C08H 8/00; C08J 5/06; C08J 5/10; C08K 5/00

(52) U.S. Cl. CPC C08J 5/045; C08L 97/005; C08H 6/00; C08H 8/00; B29C 47/662; C08J 5/10; C08K 5/0016; C08J 2300/22; C08J 5/06

(57) ABSTRACT

The present invention provides a plant based material with high tensile strength, with high E-modulus, which have low water absorption, which can be injection molded, and which can be melted and remolded. The materials of the invention may be composite materials prepared by extrusion of a mixture comprising a) surface modified plant parts consisting of finely divided plant parts O-linked to one or more groups of the structure (I); b) polymethyl methacrylate (PMMA); c) thermoplastic polymer.

### BACKGROUND

Natural fiber reinforced polymer composites has got lot of interesting properties and numerous advantages over conventional materials including lightness, resistance to corrosion, abrasion and ease of processing. Lignocellulosic fibers are even better due to their economical production and easy availability. Biofibers are nonabrasive to mixing and molding equipment, which can help to reduce the cost. The most interesting aspect of biofibers is their positive environmental effect. They are renewable resources and require little energy. The production of 100% biobased material as a substitute for petroleum based products is not an economical solution. A more viable solution will be to combine biobased and petroleum based resources to devolve a cost effective product having diverse application. The inherent polar and hydrophilic nature of lignocellulosic fiber and non-polar characteristics of most thermoplastic results in compounding difficulties leading to non-uniform dispersion of fibers within the matrix which impairs the efficiency of composite. Another main issue is, moisture absorption of natural fiber can cause swelling and presence of voids at the interface, which results in poor mechanical properties and reduced dimensional stability of composites. Chopped barley straw has been used as a suitable reinforcement for composite soil. For centuries, mixture of straw and loam, dried in the sun, were employed as construction composite.

Biocomposites comprising various thermoplastic polymers and plant based material have been described in the art. However, various challenges have been observed with such materials including insufficient tensile modulus, too high water absorption as well as challenges with re-molding.

### SUMMARY

Accordingly, injection moldable lignocellulose composites with low water absorption and good mechanical properties will be desirable compared with 100% petroleum based plastic for packaging and other applications.

There is thus a need for polymer materials, which contain high levels of biobased material, which have high tensile strength, high E-modulus, which have a low water absorption and which in the same time are injection moldable.

The present invention provides a plant based material with high tensile strength, with high E-modulus, which can be injection molded, and which can be melted and remolded. Thus, the material according to the present invention solves several technical problems associated with polymer materials described in the prior art including:
1) Providing a material having a high content of plant based material thereby reducing the need for petroleum based polymer material or for other polymer materials prepared from non-renewable sources.
2) Providing a material having a high tensile strength
3) Providing a material having a high E-modulus
4) Providing a material which can be injection molded, such as a material having a melt flow index suitable for injection molding
5) Providing a material which can be melted and remelting several times
6) Providing a material which has low water uptake.

The invention provides materials incorporating finely divided plant parts, for example finely divided cereal plant parts, which have been surface modified to be O-linked with one or more groups of the structure

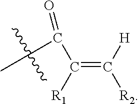

Composite materials incorporating such surface modified cereal plant parts (e.g. milled barley straw) have multiple advantageous properties including the aforementioned.

Thus, the invention provides methods for preparing a composite material, said method comprising the steps of
i) Providing a finely divided plant parts, for example finely divided plant parts of a cereal plant (cereal plant parts)
ii) O-linking the plant parts with one or more groups of the structure

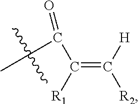

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining surface modified plant parts, for example cereal plant parts;
iii) Providing polymethyl methacrylate (PMMA)
iv) Providing a thermoplastic polymer
v) Mixing surface modified plant parts, PMMA and thermoplastic polymer;
vi) Extruding the mixture to form composite strings, which optionally are divided into cylinder granulates
   thereby preparing a composite material. It is understood that the steps of providing various materials, e.g. steps ii), iii) or iv) can be performed simultaneously or sequentially in any order. The steps v) and vi) can be performed simultaneously, partly simultaneously or sequentially in the indicated order.

The invention also provides composite materials prepared by extrusion of a mixture comprising
a) surface modified plant parts, for example cereal plant parts consisting of finely divided plant parts, (e.g. finely divided cereal plant parts) O-linked to one or more groups of the structure

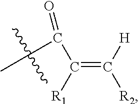

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining;
b) polymethyl methacrylate (PMMA)
c) thermoplastic polymer.

The invention furthermore comprises items prepared from the composite material.

### DRAWINGS

FIG. 1 shows the elongation as cumulative distribution of particles with CED greater than 150 μm (lower curve) and a CED smaller than 150 μm (upper curve) of hammer milled barley straw determined using a Morphologi G3SE from Malvern Instruments (Panel A). Panel B shows CED distributions of hammer milled barley straw samples by volume as determined using a Morphologi G3SE from Malvern Instruments.

FIG. 2 Panel A) shows a Scanning Electron Microscopy of straw fibers after hammer milling. Panel B) shows Inverted Microscopy of Straw fibers. Panel C) shows the particle size distribution of hammer milled barley straw.

FIG. 3 shows an overview of the extrusion process for preparing the plant based material.

FIG. 4 shows a photograph of a cup prepared by injection molding of the material.

FIG. 5 shows DSC of Straw Polymer repeated heating of same sample. The straw polymer sample described in Example 3 was heated from 25 to 190° C. at the rate of 10° C. min-1.

FIG. 6 shows pictures of a composite material extruded (compounded) once (panel A) and extruded (compounded) twice (panel B).

### DEFINITIONS

The term “approximately” as used herein in relation to numbers refers to +/−10%, preferably to +/−5%, even more preferably to +/−1%.

The term “aspect ratio” as used herein refers to width divided by length.

The term “cuticular wax” as used herein refers to waxes impregnating the cuticular membrane of plant stalks. Cuticular wax consists mainly of mixtures of hydrophobic aliphatic compounds, in particular hydrocarbons with chain lengths typically in the range C16 to C36.

The term “cylinder granulates” as used herein refers to divided composite strings obtained after extrusion. Cylinder granulates are also known as pellets.

The term “E-modulus” is a number that measures a substance's (e.g. a composite material's) resistance to being deformed elastically (i.e., non-permanently) when a force is applied to it. It defines the relationship between stress (force per unit area) and strain (proportional deformation) in a material. Details regarding how E-modulus may be determined is e.g. provided in Materials Science and engineering an Introduction by William D. Callister, Jr., Pub. Wiley 7^{th} Ed. 2007. The terms “E-modulus” and “tensile modulus” are used interchangeably herein.

The term “Melt flow index” as used herein refers to a measure of the ease of flow of the melt of a substance, e.g. of a composite material. It is defined as the mass of substance, in grams, flowing in ten minutes through a capillary by a pressure applied via a gravimetric weights at a given prescribed temperature. If nothing else is specified usually a capillary having a diameter of approx. 1 mm is used for determining the melt flow index. Melt flow index may abbreviated “MFI”.

The term “Polyolefin” as used refers to a polymer produced from polymerization of one or more alkenes with the general formula CₙH₂ₙ as a monomer. For example, polyethylene is the polyolefin produced by polymerizing ethylene. Polypropylene is another common polyolefin which is made from the olefin propylene. The polyolefin may also be a co-polymer.

The term “thermoplastic polymer” as used herein refers to a polymer, that becomes moldable above a specific temperature range (also referred to herein as the “melting peak”) and solidifies upon cooling. In general, a polymer is considered to be moldable herein if it has a Melt Flow Index of at least 0.5 g at a temperature above the melting peak of said polymer when determined at 7 kg using a capillary with a diameter of approximately 2 mm, e.g. 2.095 mm. A useful method for determining the melting peak is described herein below in Example 3.

### DETAILED DESCRIPTION OF THE INVENTION

### Methods of Preparing a Composite Material

The present invention provides methods for preparing a composite material, said method comprising the steps of:
ii) Providing surface modified plant parts, e.g. cereal plant parts, wherein said plant part for example may have been prepared by any of the methods described herein below in the section “Preparing surface modified cereal plant parts”, and wherein the plant part for example may be any of the cereal plant parts described herein below in the section “Cereal plant parts”;
iii) Providing polymethyl methacrylate (PMMA), which may be any PMMA, such as any PMMA described herein below in the section “PMMA”
iv) Providing a thermoplastic polymer, e.g. a polyolefin, which may be any thermoplastic polymer, such as any of the polymers described herein below in the section “Thermoplastic polymer”
v) Mixing surface modified plant parts, PMMA and thermoplastic polymer (e.g. polyolefin) and optionally one or more additional components;
vi) Extruding the mixture to form composite strings, which are divided into cylinder granulates, wherein said extrusion for example may be performed as described herein below in the section “Extrusion”
   thereby preparing a composite material, wherein steps ii), iii) and iv) may be performed simultaneously or sequentially in any order and steps v) and vi) may be performed simultaneously, partly simultaneously or sequentially in the indicated order. Typically steps v) and vi) are performed sequentially in the indicated order.

The final composite material may be the material thus prepared, and thus in some embodiments of the invention, the composite material may consist of the surface modified plant parts, the PMMA, the thermoplastic polymer (e.g. a polyolefin) and the optionally one or more additional components mixed in step v).

In particular, step v) may comprise the step of adding a compatibilizer, and thus the composite material may consist of the surface modified plant parts, the PMMA, the thermoplastic polymer (e.g. a polyolefin), the compatibilizer and the optionally one or more additional components mixed in step v). The compatibilizer may be any of the compatibilizers described herein below in the section “Compatibilizer”.

The composite material of the invention should preferably be a uniform material after extrusion. Thus, in some embodiments of the invention it may be desirable to perform multiple extrusions. For example, one or more of the components of the composite material may be added in several steps, wherein each step contains an extrusion. This may ensure a uniform composite material. Thus, it is comprised within the invention that the cylinder granulates prepared by the method may be mixed with additional components, and the new mixture is then extruded to form composite strings, which are divided into new cylinder granulates. In particular, the cylinder granulates prepared by the methods of the invention may be mixed with additional surface modified plant parts, and extruded. This procedure may be repeated as often as required to obtain a uniform composite material.

Thus, in addition to the steps described above, the methods of the invention may further comprise the steps of
vii) Mixing the cylinder granuates with surface modified plant parts, for example cereal plant parts and
viii) Extruding the mixture formed in step vii) to form composite strings, which are divided into cylinder granulates.

Steps vii) and viii) may be performed simultaneously, partly simultaneously or sequentially in the indicated order. Typically, they are performed sequentially in the indicated order. The methods of the invention may in addition to the steps mentioned above furthermore comprise the step of repeating steps vii) and viii)

Said steps vii) and viii) may in particular be performed in embodiments of the invention wherein the composite material comprises a high proportion of surface modified plant parts, in particular in embodiments where the composite material comprises more than 20%, such as more than 25%, for example more than 30%, such as more than 35% surface modified plant parts, the method may comprise the steps vii) and viii).

As mentioned above, the methods may involve mixing the surface modified plant parts, PMMA and thermoplastic polymer (e.g. polyolefin) with one or more additional components. Said additional component may be any useful component, for example compatibilizers and/or plasticizers or a dye. Thus, the additional component may for example be any of the compatibilizers or plasticizers described herein below in the section “Compatibilizers and plasticizer”.

The mixture prepared in step v) may comprise any useful ratio of surface modified plant parts, PMMA, thermoplastic polymer and additional components. In one embodiment of the invention the mixture prepared in step v) comprises
a) in the range of 15 to 70%, such as in the range of 15 to 60%, for example in the range of 15 to 50%, such as in the range of 15 to 30%, surface modified plant parts, for example cereal plant parts (w/w); and
b) in the range of 25 to 70%, such as in the range of 30 to 70%, for example in the range of 40 to 70%, such as in the range of 50 to 70% (w/w) thermoplastic polymer (e.g. a polyolefin); and
c) in the range of 1 to 20, such as in the range of 2 to 15%, such as in the range of 4 to 10% PMMA (w/w); and
d) optionally in the range of 1 to 20%, such as in the range of 1 to 15%, for example in the range of 1 to 10%, such as in the range of 1 to 5%, such as in the range of 2 to 5% (w/w) compatibilizer.

The % of surface modified plant parts, for example cereal plant parts is calculated based on the dry weight of the surface modified cereal plant parts.

In embodiments of the invention wherein the methods comprises several extrusion steps, then the mixture of step v) prepared before or together with the first extrusion may in particular comprise
a) in the range of 15 to 30%, such as in the range of 15 to 25%, for example in the range of 18 to 25%, such as in the range of 19 to 22% (w/w) surface modified plant parts, for example cereal plant parts; and
b) in the range of 30 to 70%, such as in the range of 50 to 70%, for example in the range of 60 to 70%, such as in the range of 60 to 65% (w/w) thermoplastic polymer (e.g. polyolefin); and
c) in the range of 5 to 10%, such as in the range of 5 to 8% (w/w) PMMA; and
d) optionally in the range of 1 to 20%, such as in the range of 1 to 15%, for example in the range of 1 to 10%, such as in the range of 1 to 5%, such as in the range of 2 to 5% (w/w) compatibilizer.

In such embodiments, the mixture prepared in step vii) may comprise or even consist of
a) in the range of 10 to 30%, for example in the range of 10 to 20%, such as in the range of 12 to 16%, for example approximately 14% (w/w) surface modified plant parts, for example cereal plant parts;
b) cylinder granulates prepared in the extrusion of step vi).

In embodiments of the invention wherein steps vii) and viii) are repeated, the mixture of step viii) prepared after the second extrusion may comprise or even consist of
a) in the range of 5 to 20%, for example in the range of 5 to 15%, such as in the range of 8 to 12%, for example approximately 10% (w/w) surface modified plant parts, for example cereal plant parts;
b) cylinder granulates prepared in the extrusion of step viii).

In some embodiments of the invention, the composite material is prepared using only one extrusion step. In such embodiments, the mixture of step vi) may comprise the same components as the final composite material, e.g. the components described herein below in the section “Composite material”.

It is also comprised within the invention that the method comprises one or more additional extrusion steps. Thus, the cylinder granulates prepared in the step vi) may be subjected to one or more steps of extrusion. It is also comprised within the invention that the cylinder granulates prepared in step viii) may be subjected to one or more steps of extrusion. This may be done in order to obtain a more homogenous material.

It is also comprised within the invention that the methods may comprise multiple extrusion steps, where cylinder granulates from different batches are extruded together to obtain fewer bigger batches.

### Composite Material

The invention provides composite materials prepared by extrusion of a mixture comprising
a) surface modified plant parts, for example cereal plant parts, wherein said plant parts, for example cereal plant part for example may have been prepared by any of the methods described herein below in the section “Preparing surface modified cereal plant parts”, and wherein the cereal plant part for example may be any of the cereal plant parts described herein below in the section “Cereal plant parts”; and
b) polymethyl methacrylate (PMMA), which may be any PMMA, such as any PMMA described herein below in the section “PMMA”; and
c) thermoplastic polymer, e.g. a polyolefin such as any of the thermoplastic polymers described herein below in the section “Thermoplastic polymer”; and
d) optionally one or more additional components, for example any of the compatibilizers or plasticizers described herein below in the section “Compatibilizers and plasticizer” or a dye.

The composite material according to the present invention may comprise the following:
a) in the range of 20 to 70% (w/w) surface modified plant parts, for example cereal plant parts, such as in the range of 20 to 60%, for example in the range of 20 to 50%, such as in the range of 30 to 50%, preferably at least 40%, such as in the range of 40 to 60% (w/w) surface modified plant parts, for example cereal plant parts; and
b) in the range of 1 to 20%, for example in the range of 3 to 20%, such as in the range of 2 to 15%, such as in the range of 4 to 12% (w/w) PMMA; and
c) in the range of 25 to 70%, such as in the range of 30 to 60%, for example in the range of 40 to 50% (w/w) thermoplastic polymer.

In addition, to the aforementioned, the composite material of the invention may comprise in the range of 1 to 10%, such as in the range of 1 to 8%, for example in the range of 1 to 5%, such as in the range of 2 to 5% (w/w) of a plasticizer.

In addition, to the aforementioned, the composite material of the invention may comprise in the range of 1 to 20%, such as in the range of 1 to 15%, such as in the range of 1 to 10%, for example in the range of 1 to 5%, such as in the range of 2 to 5% (w/w) of compatibilizer(s). In particular, the composite material may comprise in the range of 1 to 10% (w/w) of ethylene copolymer incorporating a monomer classified as maleic anhydride.

Thus in one embodiment the composite material according to the present invention may comprise the following:
a) in the range of 20 to 70% (w/w) surface modified plant parts, for example cereal plant parts, such as in the range of 20 to 60%, for example in the range of 20 to 50%, such as in the range of 30 to 50%, preferably at least 40%, such as in the range of 40 to 60% (w/w) surface modified plant parts, for example cereal plant parts; and
b) in the range of 1 to 20%, for example in the range of 3 to 20%, such as in the range of 2 to 15%, such as in the range of 4 to 12% (w/w) PMMA; and
c) in the range of 25 to 70%, such as in the range of 30 to 60%, for example in the range of 30 to 55%, such as in the range of 40 to 50% (w/w) polyolefin; and
d) in the range of 1 to 20%, such as in the range of 1 to 15%, such as in the range of 1 to 10%, for example in the range of 1 to 5%, such as in the range of 2 to 5% (w/w) of compatibilizer(s).

In one embodiment of the invention the mixture prepared in step v) comprises
a) in the range of 40 to 60% surface modified plant parts, for example cereal plant parts (w/w); and
b) in the range of 30 to 55% (w/w) polyolefin; and
c) in the range of 2 to 15% PMMA (w/w); and
d) optionally in the range of 1 to 15% (w/w) compatibilizer.

The composite material of the present invention has several advantageous properties including the following:

The composite material has a high content of plant-based material. Preferred content of surface modified plant parts, for example cereal plant parts, is described above. However, the surface modified plant parts, for example cereal plant parts according to the invention are prepared by gas phase acylation, which is a method resulting in a moderate modification, then the weight of the plant parts, for example cereal plant parts is generally not significantly different from the dry weight of the surface modified plant parts, for example cereal plant parts. Thus, the majority of the weight of the surface modified cereal plant parts is constituted by the plant parts, for example cereal plant parts per se.

The composite material of the invention also has sufficient tensile strength, e.g. sufficient tensile strength for use as a packaging material for consumer products, such as food products or beverages. The “tensile strength” may also be referred to as “Stress at Break” herein. Preferably, the composite material has a tensile strength of at least 18 MPa, such as at least 19 MPa, 20 MPa, preferably of at least 25 MPa, for example of at least 30 MPa. The tensile strength is preferably determined at 23° C., at 2 mm/min. More preferably, the tensile strength is determined according to ISO 527/3 type 2.

The composite material of the invention preferably has a high E-modulus. Preferably, the composite material has an E-modulus of at least 1500 MPa, preferably of at least 2000 MPa, even more preferably of at least 2500 MPa, such as of at least 3000 MPa. In one preferred embodiment the composite material has an E-modulus of at least 3000 MPa, and in particular the composite material may comprises at least 40%, preferably in the range of 40 to 50% (w/w) surface modified plant parts, for example cereal plant parts and have an E-modulus of at least 3000 MPa. In another embodiment, the composite material may comprises at least 20%, preferably in the range of 20 to 40% (w/w) surface modified plant parts, for example cereal plant parts and have an E-modulus of at least 1500 MPa. The E-modulus is in general determined by applying force to a specimen, typically a pulling force, at a specified temperature. The E-modulus is preferably determined at 23° C., at 2 mm/min. Methods for calculating E-modulus are described e.g. in Materials Science and engineering an Introduction by William D. Callister, Jr., Pub. Wiley 7^{th} Ed. 2007. More preferably the E-modulus is determined according to ISO 527/3 type 2.

In some embodiments the composite material of the invention may have a high flexural modulus. Preferably the composite material has a flexural modulus of at least 1000 MPa, such as at least 1200 MPa, for example at least 1400 MPa, such as at least 1500 MPa. The flexural modulus is preferably determined at 23° C. according to ISO 178.

The composite material according to the invention has a suitable melt flow index, which allows injection molding of the material. Preferably, the composite material has a melt flow index of at least 0.5 g, preferably in the range of 0.5 to 10 g, more preferably the composite material has a melt flow index in the range of 0.5 to 3 g. Said melt flow index is preferably determined at 190° C. with 7 kg weight using a capillary with a diameter of approximately 2 mm, e.g. 2.095 mm. A material with lower melt flow index cannot readily be injection molded. A material with higher melt flow index may be too fluid to properly control an injection molding process. Melt flow index may for example be determined as described in the similar standards ASTM D1238 and ISO 1133. The composite material according to the invention can be melted and remelting several times. Preferably, the material has a melting peak, which does not significantly change after melting of the material. The melting peak refers to the temperature interval at which the material changes from solid form to moldable form. Thus, the melting peak can be considered to be the same as the melting temperature range. Thus, it is preferred that the melting peak does not differ by more than 10° C., preferably not by more than 5° C. before the material has been melted and after melting twice. In particular, it is preferred that the onset temperature of the melting peak does not differ by more than 10° C., preferably not by more than 5° C., more preferably not by more than 2° C. before the material has been melted and after the material has been melted twice. It is also preferred that the peak temperature of the melting peak does not differ by more than 10° C., preferably not by more than 5° C., more preferably not by more than 2° C. before the material has been melted and after the material has been melted twice. The melting peak, including the onset temperature and the peak temperature may be determined by any useful method. It is however of importance that the same method is used for determining the melting peak temperatures before melting and after melting twice. For example, the melting peak, including the onset temperature and the peak temperature may be determined as described in Example 3.

An additional beneficial property of the composite material according to the invention is the low water swelling. The low water swelling renders the composite material useful for multiple uses, where the composite material may come into contact with water or water containing materials. Thus, for example the composite material is useful for preparing containers, such as containers for food products or beverages. It is preferred that the composite material according to the present invention has a water uptake of at the most 5%, preferably of at the most 3%, yet more preferably of at the most 1% after being immersed in water for 24 h at room temperature (e.g. at 20° C.). It may also be preferred that the composite material has a water uptake of at the most 1% after being immersed in water for 600 h at room temperature. In particular, the composite material may comprise at least 40%, preferably in the range of 40 to 50% (w/w) surface modified plant parts, for example cereal plant parts, and have a water uptake of at the most 1% after being immersed in water for 24 h or after 600 h at room temperature.

### Extrusion

The methods of the invention comprises the step of mixing the components of the composite material, including mixing the surface modified plant parts, for example cereal plant parts, the PMMA and the thermoplastic polymer (e.g. a polyolefin) followed by extrusion. The components may also be mixed in the extruder, in which case the step of mixing and the step extruding is performed simultaneously.

Extrusion involves heating the mixture to a temperature, which is sufficiently high to ensure melting of the thermoplastic polymer. Thus, the extrusion involves heating of the mixture to a temperature 160 to 200° C., such as in the range of 170 to 190° C., for example in the range of 175 to 185° C., such as to approximately 180° C. Aforementioned temperatures are for example useful in embodiments of the invention wherein the thermoplastic polymer is high density polyethylene.

In particular, the extrusion may be performed at a temperature of in the range of 160 to 200° C., such as in the range of 170 to 190° C., for example in the range of 175 to 185° C., such as to approximately 180° C.

The mixture comprising surface modified plant parts, for example cereal plant parts, thermoplastic polymer (e.g. polyolefin) and PMMA is fed into an extruder. Said mixture may be a crude mixture comprising e.g. pellets or larger lumps of the individual compounds. The extruder may be any extruder known to the skilled person. In one embodiment of the invention, the extruder is a screw extruder, comprising a hopper connected to a barrel containing the screw. In particular, the screw extruder may be a single screw extruder. The screw extruder may however also be a twin-screw extruder, for example a co-rotating or a counter-rotating twin-screw extruder. The barrel is also connected to a heating device and to means for rotating the screw(s), as well as to a die. The hopper may be mounted on the barrel or otherwise connected to the remainder of the extruder. Typically, the mixture comprising surface modified plant parts, for example cereal plant parts, thermoplastic polymer (e.g. polyolefin) and PMMA may be fed to a hopper, from where it is fed to the barrel of the extruder. Typically it is fed to one end of the barrel (also referred to as the “rear end”), where it comes into contact with the screw(s). The rotating screw(s) forces the mixture forward into the heated barrel. The rotation of the screw(s) may be set to any useful speed, e.g. up to 120 rpm. In particular, the speed may be kept at a speed for 20 to 100 rpm, such as at 30 to 50 rpm, for example at 30 to 40 rpm. If the extruder contains more than one screw, each screw may be rotating at individual speed and they may be rotating in the same direction or in opposite directions.

The barrel is typically connected to one or more heating devices ensuring a high temperature in the barrel. The desired extrusion temperature may be equal to the temperature of the barrel, however it is also comprised within the invention that a heating profile is set for the barrel in which three or more independent PID-controlled heater zones gradually increase the temperature of the barrel from the rear end to the front. This allows gradually melting as mixture is pushed through the barrel and lowers the risk of overheating which may cause degradation. Extra heat is contributed by the intense pressure and friction taking place inside the barrel. Accordingly, the extruder may also be connected to cooling devices, e.g. fans to keep the temperature below a set value if too much heat is generated. Preferably, at least part of the barrel is kept at a temperature in the range of 160 to 200° C., such as in the range of 170 to 190° C., for example in the range of 175 to 185° C., such as to approximately 180° C. The barrel may be equipped with one or more vents, which can be used for venting atmosphere gases or moisture contained within the mixture.

At the front of the barrel, the molten mixture may leave the screw to travel through a die connected to the barrel by any useful means. The die may be a plate with holes. The plate may for example be a thick metal with a plurality of circular holes. The mixture is forced through the holes resulting in formation of composite strings. The mixture is extruded through the holes and may be cut as it leaves the die to form cylinder granulates. Alternatively, the composite strings may be cut later to form cylinder granulates. Cylinder granulates are also known as “pellets”.

After extrusion, the composite strings or the cylinder granulates may be cooled, e.g. in a water bath or under water sprays.

The cylinder granulates may be dried, e.g. dried by nay conventional means. For example the cylinder granulates may be dried in a vacuum oven at elevated temperatures, e.g. at a temperature in the range of 50 to 150° C., for example in the range of 80 to 120° C.

As described herein above, the step of extrusion may be repeated one or more times. This may be done in order to obtain a more homogenous mixture. Various extruders may be more or less efficient in mixing the components. Thus, for example if a single screw extruder is used, then it may sometimes be advantageous to repeat the step of extrusion. In other embodiments a twin-screw extruder is employed, which frequently results in a more homogenous material. In such cases, fewer extrusion step(s) may be sufficient. Thus, in one embodiment the method comprising in the range of 1 to 3 steps of extrusion, such as in the range of 1 to 2 steps of extrusion, wherein the extrusion is performed using a twin-screw extruder.

### Injection Molding

One advantage of the composite material according to the invention is that it is injection moldable. Thus, in one embodiment the invention relates to an item prepared by injection molding the composite material of the invention. The invention also relates to methods for producing an item by injection molding the composite material according to the invention into said item.

Injection molding may be performed by any injection molding method available to the skilled person. Injection molding in general comprise heating the composite material to a temperature above the melting peak of the composite material and injecting the material into a mold.

Thus, the composite material may for example be in the form of cylinder granulates may be fed into a heated barrel, mixed, and forced into a mold cavity. In particular, the composite material e.g. in the form of cylinder granulates may be fed to a hopper, from where it is fed to the barrel. Typically, the composite material e.g. in the form of cylinder granulates are fed (e.g. via the hopper) to one end of the barrel (also referred to as the “rear end”), where it comes into contact with the screw(s). The rotating screw(s) forces the composite material forward into the heated barrel. If the barrel contains more than one screw, each screw may be rotating at individual speed and they may be rotating in the same direction or in opposite directions. Instead of a screw, the barrel may comprise a ram, which can move the composite material from one end of the barrel to the other. The barrel is typically connected to one or more heating devices ensuring a high temperature in the barrel in a similar manner as described herein above for the extruder. Typically, the injection molding is performed at a temperature in the range of 150° C. to 250° C., such as in the range of 160° C. to 230° C., for example in the range of 180° C. to 210° C., such as in the range of 190° C. to 200° C. Accordingly, it is preferred that at least part of the barrel is kept at a temperature in the range of 150° C. to 250° C., such as in the range of 160° C. to 230° C., for example in the range of 180° C. to 210° C., such as in the range of 190° C. to 200° C.

The molten composite material feeds forward and in general collects at the front of the screw into a volume known as a shot. A shot is the volume of material that is used to fill the mold cavity. When enough composite material has gathered, the material is forced at high pressure and velocity into the mold. This pressure may for example be generated by the screw. After filling or during filling the last part of the mold a holding pressure may be applied until the material is starting to solidify. Once the material is starting to solidify, the screw may reciprocate and acquire material for the next cycle, while the material within the mold cools so that it can be ejected and be dimensionally stable.

The sequence of events during the injection molding may be viewed as a cycle. The cycle begins when the mold closes, followed by the injection of the molten composite material into the mold cavity. Once the cavity is filled, a holding pressure is maintained to compensate for material shrinkage. In the next step, the screw turns, feeding the next shot to the front screw. This causes the screw to retract as the next shot is prepared. Once the part is sufficiently cool, the mold opens and the part may be ejected.

The injection molding may be performed using a scientific or decoupled molding, where the applied pressure may be altering during the process,

The cooling may be aided by use of a cooling device, e.g. cooling lines circulating water or oil from an external temperature controller.

The mold may be made of any useful material e.g. metal, such as steel. Molds can be of a single cavity or multiple cavities. In multiple cavity molds, each cavity can be identical and form the same parts or can be unique and form multiple different geometries during a single cycle.

### Cereal Plant Parts

The plant parts to be used with the invention may be any plant parts. In preferred embodiments the plant parts are cereal plant parts.

The cereal plant parts may be parts of any cereal plant. Said cereal plant may be any member of the Graminae plant family. Cereal plants include, but are not limited to barley (Hordeum), wheat (Triticum), rice (Oryza), maize (Zea), rye (Secale), oat (Avena), sorghum (Sorghum), and Triticale, a rye-wheat hybrid. In one embodiment of the invention the cereal plant is barley (Hordeum).

The plant parts may be any parts of said cereal plants, however, preferably the plant parts are fiber rich parts, which are generally of limited use. Thus, cereal plants are cultivated primarily for their starch-containing seeds or kernels. Thus, the cereal plant parts may in particular primarily or exclusively comprise any parts of the cereal plant other than the seeds or kernels.

Thus, in one embodiment, the cereal plant parts are selected from the group consisting of straw, roots, husks and mixtures of the aforementioned. In one particular embodiment the cereal plant part is straw, e.g. barley straw.

In another embodiment, the cereal plant part is a left over from production using cereal as a base material. For example the cereal plant part may be malt dust, which is left over dust obtained during malt production. Thus, the cereal plant part may be parts of a malted barley. In another embodiment of the invention the cereal plant part is root, e.g. root spikes. Root spikes may also be obtained as a waste product during malt production. In another embodiment the cereal plant part is barley dust. Similar to malt dust, barley dust may be a leftover from barley beer production, i.e. beer production using barley as base material rather than malt. The cereal plant part may also be mash, i.e. malt based mash and/or barley based mash.

The cereal plant parts to be used with the invention may also be mixtures of any of the aforementioned.

The cereal plant parts to be used with the invention should be finely divided. Malt dust or barley dust may already be finely divided from the onset. However other cereal plant parts may be present as larger parts. In such embodiment, it is preferred that the cereal plant part are finely divided by any useful method.

In one preferred embodiment of the invention the cereal plant parts are milled, preferably milled using a hammer mill. More preferably, the hammer mill may be connected to a device which removes the smallest particles obtained by milling. For example particles having a particle size smaller than 5 μm may be removed. For example, such articles may be removed by blowing.

In a preferred embodiment of the invention, the cereal plant part is barley, more preferably barley straw. Very preferably, the finely divided cereal plant parts are hammer milled barley straw.

It preferred that the finely divided cereal plant parts primarily have an elongated shape. This may be achieved e.g. by hammer milling of cereal plant parts, e.g. of straw. It is preferred that the majority of the particles have an elongated shape. Preferably, at least 40%, such as at least 50% of the particles of the finely divided cereal plant parts are elongated.

One measure for elongated shape is the aspect ratio, which herein is defined as the width divided by the length. Accordingly, a spherical particle will have an aspect ratio close to 1, whereas an elongated particle will have an aspect ratio somewhat lower than 1. Thus, it is preferred that at least 40% of the particles of the finely divided cereal plant parts have an aspect ratio of at the most 0.6, such as at the most 0.5. It may also be preferred that at least 50% of the finely divided particles have an aspect ratio of at the most 0.6, such as at the most 0.5. The aspect ratio may be determined by microscopic examination of a representative sample of the finely divided cereal plant parts. For example, any conventional method for determining aspect ratio of particles may be employed, in particular such methods which are based on laser diffraction particle sizing and/or on automated measurements of size and shape of particles by static image analysis. Alternatively, the aspect ratio may be determined using the Morphologi G3SE automated image analysis system (Malvern Instruments). Another measure for elongated shape is the elongation, which is 1 minus the aspect ratio. Thus, a spherical particle will have an elongation close to 0, whereas an elongated particle will have an elongation somewhat higher than 0. Thus, it is preferred that at least 40% of the particles of the finely divided cereal plant parts have an elongation of at least 0.4, such as at least 0.5. It may also be preferred that at least 50% of the finely divided particles have an elongation of at least 0.4, such as at least 0.5. The elongation may be determined by microscopic examination of a representative sample of the finely divided cereal plant parts. Alternatively, the elongation may be determined using the Morphologi G3SE automated image analysis system (Malverne Instruments).

It may also be preferred that the finely divided cereal plant parts consist of particles, wherein at least 90% of the particles have a particle size in the range of 5 to 2000 μm.

The finely divided cereal plant parts may be surface modified as described herein below in the section “Preparing surface modified cereal plant parts”.

### Preparing Surface Modified Cereal Plant Parts

The composite materials according to the present invention are prepared by extruding a mixture containing a thermoplastic polymer (e.g. a polyolefin), PMMA and surface modified finely divided plant parts, for example cereal plant parts.

The following description relates to preparing surface modified cereal plant parts. However other plant parts may be surface modified in the same manner.

The finely divided cereal plant parts, e.g. any of the finely divided cereal plant parts described herein above in the section “Cereal plant part” may be surface modified by any useful method, e.g. by any of the methods described herein in this section.

Prior to surface modification, the finely divided cereal plant parts may be treated to remove wax. In general it is preferred that the cereal plant parts are not subjected to other pre-treatments, apart from treatment to remove wax. This ensures that the cereal plant parts contain intact plant fibers. In particular, it may be preferred that the cereal plant parts are not subjected to chemical and thermal treatments used for preparing pulp.

Wax may be removed by any suitable method, which does not extensively alter the cereal plant fibers. In particular, wax may be removed by alkaline treatment of the finely divided (e.g. the milled) cereal plant parts. The alkaline treatment may be treatment with a solution of a strong base, such as NaOH in water. The solution may contain in the range of 0.1 to 1.0%, for example in the range of 0.2 to 0.5%, such as approximately 0.32% (v/v) of said strong base. Typically, the finely divided cereal plant parts are incubated with said solution at elevated temperature, e.g. at a temperature of at least 60° C., preferably at least 70° C., such as in the range of 70 to 90° C., for example in the range of 75 to 85° C., such as at approximately 80° C.

In addition to removal of wax, said treatment may also cause removal of at least some lignin. However, it is preferred that the finely divided cereal plant parts retain at least 40%, such as at least 50% of the lignin after removing wax.

After the treatment to remove wax, the finely divided cereal plant parts may be optionally be dried, e.g. by incubation at elevated temperature and/or at low pressure. For example the cereal plant parts may be incubated at a temperature in the range of 50 to 200° C., such as in the range of 80 to 120° C., for example in the range of 90 to 100° C. For example the cereal plant parts may be incubated at a pressure below atmospheric pressure, e.g. under vacuum.

The finely divided cereal plant parts, which have optionally been subjected to a step of wax removal are then surface modified by —O-linking with one or more groups of the structure

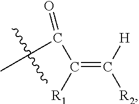

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen. In particular, R₁ may be selected from the group consisting of C₁₋₆ alkyl and —H, for example R₁ may be methyl. In particular, R₂ may be selected from the group consisting of C₁₋₆ alkyl and —H, for example R₂ may be —H.

The surface modification may comprise the steps of:

a) providing finely divided cereal plant parts, which optionally have been treated to remove wax, b) providing an acylation reagent of the formula

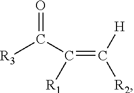

wherein R₁ and R₂ independently are selected from the group consisting of —H, C₁₋₆-alkyl, C₁₋₆-alcohols, C₁₋₆alkoxy, C₁₋₆ ethers, C₂₋₆ alkenyl, halogen and C₁₋₆ alkyl substituted with halogen and R₃ is selected from such groups that constitute or contain leaving groups, for example R₃ may be selected from the group consisting of halides, C₁₋₆-alkyl halides, C₁₋₆ alkyl sulfonates, halo C₁₋₆-alkylsulfonates, azides, mixed anhydrides, mixed carbonic anhydrides, C₂₋₆-alkenylhalides, arylhalides, N-methylimidazole,

c) contacting said finely divided cereal plant parts with said acylation reagent, wherein said reagent is kept in gas phase, and

d) obtaining a material comprising finely divided cereal plant parts covalently —O-linked one or more groups of the structure

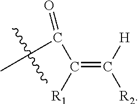

The waved line as used herein indicated the point of attachment to the cereal plant parts.

The surface modification may also be referred to as grafting herein and the method of surface modification may be referred to as the grafting process or the surface modification process. Preferably, the acylation reagent is kept is gas phase as described above, in which case the method may be referred to as a gas phase grafting process.

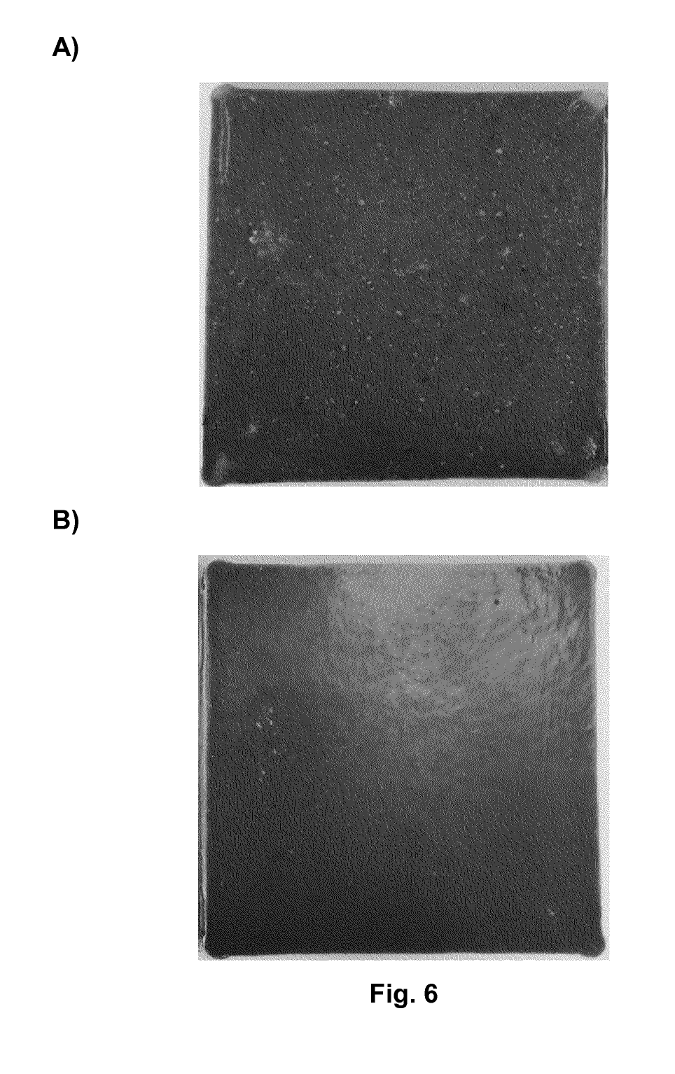

The finely divided plant parts may be O-linked as a batch process or as a continuous process. In one embodiment, the O-linking is performed as a continuous process, wherein finely divided cereal plant parts continuously are contacting with an acylation reagent kept in gas phase. For example, the finely divided plant parts may be transported to a container while an acylation reagent in gas phase is directed to the container. E.g the finely divided plant parts may be transported to a fluid bed while an acylation reagent in gas phase is directed trough the fluid bed. The temperature of the acylation reagent as well as of the container, e.g. the fluid bed is controlled. Acylation reagent can continuously be directed to the container, e.g. through the fluid bed. The finely divided plant parts can be fed to the container, e.g. the fluid bed through an opening, e.g. with the aid of a screw. A non-limiting example of a useful apparatus for continuous surface modification, which can be used to O-link the finely divided plant parts according to the invention are shown in FIG. 6 of international patent application WO 2010/069330 and the surface modification may be performed as described in relation to FIG. 6 in WO 2010/069330.

To retain the acylation reagents in the gas phase when directing them over or through the cereal plant parts, the cereal plant parts may be pre-heated before initiating the grafting process. The temperature of the process container (fluid bed) may also be controlled and maintained throughout the grafting process. Preferably, the grafting process occurs at a temperature below 200° C., such below 175° C., e.g below 150° C., such as below 125° C. For example, the reaction may take place at a temperature in the range of 50 to 150° C., preferably in the range of 70 to 110° C., more preferably in the range of 80 to 100° C., even more preferably in the range of 85 to 95° C., for example in the range of 88 to 92° C., for example at approximately 90° C. In order for the reaction to take place at the aforementioned preferred temperatures, it is preferred that the cereal plant parts are kept at said temperature. This may be achieved by any suitable method known to the skilled person for example by placing the cereal plant parts in a water, oil or sand bath with the desired temperature, by heating the container containing the cereal plant parts with steam or by microwave heating.

The grafting process can be performed at various pressures in the range of 0.001 bar to 200 bar to increase volatility of the reagents at lower pressures or to increase the concentration of a volatile reagent at the site of reaction at higher pressures. In a preferred embodiment the process pressure is 0.5-2 bar. In a more preferred embodiment of the process the pressure is 1 bar.

In a preferred embodiment the combination of the groups R₁, R₂ and R₃ of the acylation reagent does not contain more than 25, more preferred less than 10 such as five carbon atoms in total. The preferred boiling point of the reagent of interest at atmospheric pressure is below 200° C. The use of a recirculating carrier gas may facilitate the evaporation of the reagent even below the boiling point of said reagent.

Preferably a homogeneous temperature is maintained throughout the reaction vessel (fluid bed) when the grafting process is performed.

If the grafting process is performed in vacuum the cereal plant parts are preferably pre-treated i.e. pre-dried at a temperature and vacuum at which the grafting process is to be performed. Performing the grafting process in vacuum may be preferred as this reduces or eliminates any risk of explosion of dust.

The cereal plant parts may be stirred or agitated when the grafting process is performed. The gas stream of the acylation reagent through the bed of the cereal plant parts should preferably not be laminar. A turbulent flow of gas is preferred.

The rate of forward reaction can be increased by passing reactant gas and dry air occasionally to drive out the HCl gas byproduct if HCl is produced. This will typically be the case if R₃ is —Cl. Reactant gas can be passed through the material to be surfaced coated for e.g. 3 minutes followed by 2 minutes of a flow of dry air or nitrogen to remove the HCl gas and to push the reaction forward. The interval of 3 min of reactant gas and 2 min of a non-reactant gas can be repeated throughout the reaction time. The used times can also be 2 min of reactant gas and 1 min of a non-reactant gas, 2 min of reactant gas and 2 min of a non-reactant gas, 3 min of reactant gas and 1 min of a non-reactant gas, 3 min of reactant gas and 3 min of a non-reactant gas. If HCl is produced when the reagents react with the surface of the material, this HCl can be trapped e.g. by zeolite. The zeolite can be regenerated. Other leaving groups may also be removed from the gas phase. If formed HBr can be removed with 4 Å molecular sieves. HBr may in particular be formed if R₃ is —Br. Organic acids and sulphonic acids may be trapped with proton sponge or trialkylamino resins.

In a preferred embodiment a carrier gas is used to circulate the acylation reagent which is in gas phase. Preferred carrier gases are selected from group of helium, neon, argon, nitrogen, hydrogen, oxygen, air, chlorine, trimethylamin, dimethylamine methylamine, dimethyl ether, carbon monoxide, carbon dioxide, carbondisulfide, sulfurdioxide, hydrogen Sulfide, hydrogenchloride, nitric oxide, nitrogen dioxide, alkanes (CₓH₂ₓ₊₂), fluoroalkanes, isobutane, ethene, propylene, butane, butadiene, cyclopropane, cyclobutane, ethyleneoxide, Isobutylene, acetone acetylene, propyne, methylchloride.

Liquids such as water, triethylamine, pyridine, carbon tetrachloride etc. may be gasified and used as carrier gasses at temperatures above their boiling points.

In one embodiment the carrier gas is selected from the group consisting of noble gasses, nitrogen, air, carbon dioxide, carbon disulfide and alkanes. For example, the carrier gas may be nitrogen or carbon dioxide due to the low cost and inertness of these gases. In another embodiment the carrier gas is trimethylamine.

In a preferred embodiment temperature control is performed of all the acylation reagents, carrier gasses and cereal plant parts as well as the produced product (surface modified cereal plant parts). Preferably the temperature of the acylation reagent in gas phase, the carrier gasses and the starting cereal plant parts is uniform. A similar temperature is maintained throughout the surface modifying process. Temperature controlling means can thus be connected to the container for the starting material (i.e. the finely divided cereal plant parts), to the reaction vessel (may be the same as the container for the starting material), to a container for surface modified material (if present), to the vessel for heating the acylation reagent(s) and to the vessel for the carrier gas (if present) as well as to the tubes connecting the described units (containers and vessels). Preferred temperatures are described elsewhere herein.

In another preferred embodiment pressure control is performed on all the acylation reagents, carrier gasses and starting material (i.e. finely divided cereal plant parts) and less preferred on the produced product (surface modified material). Preferably, the pressure of the acylation reagent(s) in gas phase, the carrier gasses and the starting material is uniform. A similar pressure may be maintained throughout the surface modification process. The pressure may also be varied e. g. oscillated between high and low pressure to increase the contact of reagents with irregular surfaces. Pressure controlling means can thus be connected to the container for the starting material, to the reaction vessel (may be the same as the container for the starting material), to a container for surface modified cereal plant parts (if present), to the vessel for heating the reagent(s) and to the vessel for the carrier gas (if present) as well as to the tubes connecting the described units (containers and vessels). The pressure is controlled in respect of a desirable temperature and concentration of the reagent(s). Preferred pressures are described elsewhere herein.

In a further embodiment gas flow rate control is performed when the acylation reagents in gas phase optionally together with a carrier gas is directed through the reaction vessel containing the finely divided cereal plant parts. Means for gas flow rate control can thus be connected to the container for the starting material, to the reaction vessel (may be the same as the container for the starting material), to a container for surface treated material (if present), to the vessel for heating the reagent(s) and to the vessel for the carrier gas (if present) as well as to the tubes connecting the described units (containers and vessels). The gas flow rate is preferably regulated to minimize the influence of diffusion of the reaction rate i. e. to ensure an excess of reagent at the surface at all times throughout the reactor. The preferred gas flow can also be lower in order to control development of hot spots due to heat of reaction. The preferred rate of gas is in case of a fluid bed reactor may be equivalent to the flow that provides the optimal fluidization without bumping of the material. The preferred flow rate therefore depends on the physical nature of the material to be derivatised. A typical linear flow rate is in the range of 10 cm/min to 50,000 cm/min such as 30 cm/min to 10,000 cm/min, e.g. 100 to 2,000 cm/min, such as 300 cm/min to 1,000 cm/min e.g. about 600 cm/min.

The feeding rate of the acylation reagent may be (1-1000 mmol/liter of reaction volume)/min. For example, the feeding rate of the acylation reagent may be (1-100 mmol/liter of reaction volume)/min.

Means for controlling the feeding rate of the acylation reagent may thus be connected to the reaction vessel and to the vessel for heating the reagent(s). Optionally means for controlling the feeding rate of the finely divided cereal plant parts may be connected to the container for the starting material, to the reaction vessel (may be the same as the container for the starting material), and to a container for surface treated material (if present).

The treatment time i.e. the time reactant(s) in gas phase is directed over the surface of a material can be e.g. in the range of 0.1 to 50 hours, preferably in the range of 0.3 to 25 hours, more preferably in the range of 0.5 to 15 hours, even more preferably in the range of 1 to 10 hours, yet more preferably in the range of 1 to 4 hours, even more preferably for in the range of 1 to 2 hours.

However, the reaction times may also be 1 min to 50 hours, preferably in the range of 2 min to 25 hours, more preferably in the range of 3 min to 15 hours, even more preferably in the range of 4 min to 10 hours, yet more preferably in the range of 5 min to 7 hours, even more preferably for approximately 6 hours, such as for 6 hours.

In another preferred embodiment excess of acylation reagent is present at all times during the time when the acylation reagent in gas phase is directed over the finely divided cereal plant parts. By “excess of acylation reagent” is meant that the amount of acylation reagent(s) in gas phase when the gas has passed by the material in the reaction vessel or when the gas phase leaves the reaction vessel at least some reagent(s) are in the gas leaving the reaction vessel. Measuring means to measure the concentration of reagent(s) in the gas phase can thus be connected to the gas inlet and gas outlet of the reaction vessel, to the vessel for heating the reagent(s) and/or to an aggregate combining the heated reagent(s) with the carrier gas.

In a preferred embodiment, the surface modification is undertaken as a gas phase reaction, wherein the finely divided cereal plant parts are provided in solid state and a compound of the formula

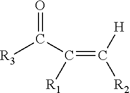

is provided in gas phase. R₁ and R₂ are independently selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen. Preferably, R₁ and R₂ are independently selected from the group consisting of C₁₋₆ alkyl and —H. In particular, R₁ may be selected from the group consisting of C₁₋₆ alkyl and —H, for example R₁ may be methyl. In particular, R₂ may be selected from the group consisting of C₁₋₆ alkyl and —H, for example R₂ may be —H.

R₃ may be selected from the group consisting of groups that constitute or contain leaving groups, for example R₃ may be selected from the group consisting of halides, C₁₋₆-alkyl halides, C₁₋₆ alkyl sulfonates, halo C₁₋₆-alkylsulfonates, azides, mixed anhydrides, mixed carbonic anhydrides, C₂₋₆-alkenylhalides, arylhalides, and N-methylimidazole. More preferably R₃ is halide more preferably chloride.

Thus, the compound provided in step b) may have the R1, R2 and R3 groups as defined above,

The general structure of a mixed anhydride and a mixed carbonic anhydride are

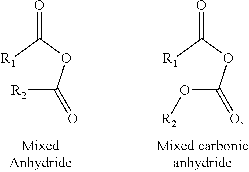

wherein R₁ and R₂ are different. R₁ and R₂ given in the general formulas for anhydrides are independent from R₁ and R₂ described herein elsewhere.

The acylation reagent of formula

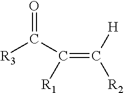

may be kept in gas phase by any suitable method known to the skilled person. For example the compound may be subjected to heating, e.g. to heating to any of the reaction temperatures described above.

A non-limiting example of a useful method for surface modification of finely divided cereal plant parts with a compound of formula

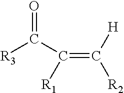

in gas phase is described in Example 1 herein below.

The degree of —O-linking is herein used to denote to what extend the cereal plant parts is covalently linked to the acylation reagent. The degree of —O-linking may be determined by a fluorescence based method, wherein double bonds are allowed to react with a free thiol group on a fluorescent dye. Difference of fluorescence between the material before reaction with the acylation reagent(s) in gas phase and the fluorescence of the surface modified material is then used as a measure of the degree of —O-linking.

Preferably, the fluorescence of the surface modified material upon reaction with said fluorescent thiol is 1-5 times higher such as at least 1.2 times higher, e.g. at least 1.3 times higher, such as at least 1.4 times higher e.g at least 1.5 times higher, more preferably at least 1.8 times higher, even more preferably at least 2.5 time higher, yet more preferably at least 3.5 times higher, such as in the range of 1 to 5 times higher e.g. in the range of 1.4 to 3 times higher than the fluorescence of the starting material when exposed to said fluorescent thiol.

The fluorescent dye may be any fluorescent dye comprising a thiol group, but in a preferred method the fluorescent dye is a cys-reactive rhodamine, preferably RMA1118-69.

### PMMA

The composite material according to the invention comprises PMMA. As used herein PMMA is an abbreviation for “Polymethyl methacrylate”. PMMA is thus a polymer of methyl methacylate subunits. In particular, PMMA may be a polymer of the general structure:

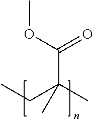

The PMMA to be used with the present invention may be PMMA having a weight average molecular weight in the range of 50,000 to 200,000, preferably in the range of 70,000 to 150,000, such as in the range of 90,000 to 110,000.

The PMMA to be used with the present invention may be PMMA having a Melt flow index of in the range of 0.5 to 20 g, preferably in the range of 1 to 10 g, more preferably in the range of 5 to 10 g, such as in the range of 7 to 9 g, for example approximately 8 g, when determined at 230° C. and 3.8 kg.

The PMMA to be used with the present invention may be PMMA having a density in the range of 1.0 to 1.3 g/cm³, preferably in the range of 1.1 to 1.2 g/cm³.

### Thermoplastic Polymer

The composite material of the present invention comprises a thermoplastic polymer. The thermoplastic polymer may be any thermoplastic polymer, and in particular any thermoplastic polymer useful for injection molding.

Thus, it is preferred hat the thermoplastic polymer has a melt flow index rendering it suitable for extrusion and injection molding. Thus, preferably the thermoplastic polymer, e.g. the polyolefin has a melt flow index of at least 0.5 g, preferably a melt flow index in the range of 0.5 to 10 g, more preferably in the range of 0.5 to 3 g/min at 190° C./5 kg.

The thermoplastic polymer may be a petroleum-based polymer. In one embodiment the thermoplastic polymer is selected from the group consisting of polyethylene, ethylene-glycidyl methacrylate copolymer, polystyrene, styrene:butadiene copolymer, poly(l-phenylethene), k-resin and polylactic acid. However, in one embodiment of the invention, the thermoplastic polymer is not polystyrene.

In one preferred embodiment of the invention, the thermoplastic polymer is a polyolefin. The polyolefin may be any polyolefin, which is a polymer produced from polymerization of alkene monomers.

It is preferred hat the polyolefin has a melt flow index rendering it suitable for extrusion and injection molding. Thus, preferably the polyolefin has a melt flow index of at least 0.5 g, preferably a melt flow index in the range of 0.5 to 10 g, more preferably in the range of 0.5 to 3 g/min at 190° C./5 kg.

In a preferred embodiment of the invention, the polyolefin is polyethylene, and more preferably the polyolefin is high-density polyethylene. High-density polyethylene may also be referred to as “HDPE” or “PE-HD” herein.

High-density polyethylene has a density of at least 0.93 g/cm³, for example a density in the range of 0.93 to 0.97 g/cm³. Preferably, the high-density polyethylene has a melt flow index of in the range of 0.5 to 3 g/min at 190° C./5 kg.

In another embodiment of the invention the polyolefin may be styrene:butadiene copolymer. Styrene butadiene copolymer may also be referred to as polystyrene poly butadiene co-polymer. Said styrene:butadiene copolymer may have a melt flow inde of in the range of 1 to 10 g, such as in the range of 5 to 10 g, for example in the range of 7 to 8, when determined at 200° C. and 5 kg.

### Compatibilizer and Plasticizer

It is preferred that the composite materials of the invention comprises a compatilizer. Thus, step v) of the method for producing a composite material described herein may preferably comprises adding a compatibilizer.

A compabilizer according to the invention is a polymer which comprises both hydrophilic and hydrophobic moieties. Thus, in one embodiment of the compatibilizer is a co-polymer polymerized from a mixture of hydrophilic and hydrophobic monomers. The compatibilizer may also be a co-polymer containing subunits where some are hydrophilic and some are hydrophobic.

Said hydrophilic monomer or subunit may for example be a monomer/subunit containing a carboxylic group, a carboxylate, a hydroxyl group, sulphonate or an anhydride. Anhydrides comprise the following moiety:

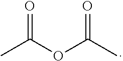

Carboxylic groups are groups of the structure —COOH. The carboxylate may be a carboxylate salt or a carboxylate ester. Carboxylate salts have the general formula M(RCOO)ₙ, where M is a metal and n is an integer. Carboylate esters have the general formula RCOOR′. Non-limiting examples of such monomers include but are not limited to maleic anhydride, C₂₋₆-hydroxy alkene, acrylates and C₁₋₆-alkylacrylate (e.g. butyl acrylate).

Said hydrophobic monomer/subunit may for example be an C₂₋₆-alkene, such as ethylene.

In one preferred embodiment the composite material according to the invention comprises compatilizer, which is a random ethylene copolymer incorporating a monomer classified as maleic anhydride. Said compatibilizer is generally added to the mixture in step v) of the methods described herein. Ethylene copolymers incorporating a monomer classified as maleic anhydride are commercially available, for example Fusabond (Dupont).

In another embodiment the compatabilizer may be polyethylene polybutylacrylate. The compatibilizer may also be a polymer of subunits, which both have hydrophilic and hydrophobic properties. Non limiting examples of such polymers include polyethylene oxide and polyvinyl alcohol.

The compatilibilizer may also be a generally hydrophobic polymer, e.g. a polyolefin, which has been substituted with hydrophilic groups, e.g. carboxylates or sulphonate. The carboxylates may be the carboxylates described in this section above.

An example of a more complex compatibilizer, which can be used with the present invention is lignin O-linked to one or more groups of the structure

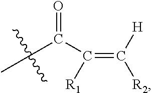

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen. Lignin may be O-linked to said groups using the same surface modification method described herein above for surface modification of cereal plant parts. Thus, in the methods described in the section “Preparing surface modified cereal plant parts”, the cereal plant parts may be substituted with lignin in order to prepare surface modified lignin. Lignin may be obtained from plants, for example lignin may be obtained from the waste water after alkaline treatment of cereal plant parts.

It is also comprised within the invention that the composite material may comprise more than one compatibilizer, e.g. the compatibilizer may comprise a mixture of the compatilbilizers mentioned herein above. For example the composite material may comprise a random ethylene copolymer incorporating a monomer classified as maleic anhydride in combination with one of the other compatibilisers mentioned herein above.

It is preferred that the composite materials of the invention comprise a plasticizer. Thus, step v) of the method for producing a composite material described herein may preferably comprise adding a plasticizer.

The plasticizer is typically a polymer having a low-density and/or a low molecular weight. Preferred plasticizers have a high Melt flow index. Thus the plasticizer may be a polymer having a melt flow index of at least 4 g/10 min when determined at 190° C. and 2.16 kg.

The plasticizer may be a polymer having a low-density, e.g. having a density of at the most 0.92 g/cm³. Frequently, the plasticizer to be used with the present invention is a polyolefin, which has above mentioned high Melt flow index. The plasticizer may in particular be a polyolefin having aforementioned high Melt flow index and a density of at the most 0.92 g/cm³.

In one embodiment, the plasticizer is selected from the group consisting of low molecular weight polypropylene, low-density polyethylene and copolymer of propylene and ethylene.

In embodiment of the invention, the composite material comprises a plasticizer, which is low-density polyethylene. Preferably, said low-density polyethylene has a density of at the most 0.92 g/cm³, such as in the range of 0.89 to 0.92 g/cm³.

In one embodiment, the plasticizer is a low molecular weight polypropylene, in particular a polypropylene having a density of at the most 0.9 g/cm³.

In a preferred embodiment, the composite material of the invention comprises a plasticizer, which is a co-polymer of propylene and ethylene. In particular, said co-polymer may be an amorphous metallocene propylene-ethylene-copolymer. In particular, said co-polymer may have a density of at the most 0.92 g/cm³, for example a density in the range of 0.8 to 0.9 g/cm³. Said co-polymer may furthermore jave a viscosity in the range of 1000 to 3000 mPa*s, such as in the range of 1500 to 2100 mPa*s. A useful amorphous metallocene propylene-ethylene-copolymer is Licocene® PP 1502 available from Clariant.

### Item

The present invention provides a method of preparing an item of the composite material according to the invention. In particular, said methods may comprise injection molding of the composite material by any of the methods described herein above in the section “Injection molding”. The invention also provides items prepared from the composite material according to the invention.

The composite material according to the invention is useful for a number of different purposes, and thus a wide variety of items may be prepared from the material. For example, the item may be a container for food storage. The container for food storage may be for example be selected from the group consisting of crates, cans, boxes, glass substitutes and table utensils. The item may also be a container e.g. for liquids. Suitable shapes for containers e.g. containers for liquid includes for example various bottle shapes, cubic shapes, cylindrical shapes and boxes, preferably, the container for liquid is a bottle. The entire container e.g. the bottle may be prepared from the composite material of the invention, however, parts thereof may be prepared from another material, e.g. any closure means (such as a lid or a cap, for example a crown cap) may be prepared from another material, for example metal (such as aluminium or iron) and/or conventional plastic.

### EMBODIMENTS

The invention is further defined by the following embodiments:
1. A method of preparing a composite material, said method comprising the steps of
   i) Providing a finely divided plant parts of a cereal plant (cereal plant parts)
   ii) O-linking the cereal plant parts with one or more groups of the structure

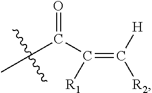

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining surface modified cereal plant parts;
iii) Providing polymethyl methacrylate (PMMA)
iv) Providing a thermoplastic polymer
v) Mixing surface modified plant parts, PMMA and thermoplastic polymer;
vi) Extruding the mixture to form composite strings, which optionally are divided into cylinder granulates
thereby preparing a composite material, wherein the steps may be performed in any order.
2. A method of preparing a composite material, said method comprising the steps of
   i) Providing a finely divided plant parts
   ii) O-linking the plant parts with one or more groups of the structure

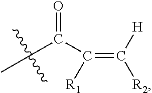

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining surface modified plant parts;
iii) Providing polymethyl methacrylate (PMMA)
iv) Providing a thermoplastic polymer
v) Mixing surface modified plant parts, PMMA and thermoplastic polymer;
vi) Extruding the mixture to form composite strings, which optionally are divided into cylinder granulates,
thereby preparing a composite material, wherein the steps may be performed in any order.
3. The method according to any one of the preceding embodiments, wherein the steps are performed in the indicated order.
4. The method according to any one of embodiments 1 and 2, wherein the steps iii) and iv) are performed simultaneously or sequentially in any order and wherein steps iii) and iv) may be performed prior to step i) or after step ii), and wherein steps v) and vi) may be performed simultaneously, partly simultaneously or sequentially in the indicated order.
5. The method according to any one of the preceding embodiments, wherein the method further comprises the steps of
   vii) Mixing the cylinder granuates with surface modified cereal plant parts or surface modified plant parts and
   viii) Extruding the mixture formed in step vii) to form composite strings, which are divided into cylinder granulates wherein steps vii) and viii) may be performed simultaneously or sequentially in the indicated order.
6. The method according to embodiment 5, wherein steps vii) and viii) are performed sequentially in the indicated order.
7. The method according to any one of embodiments 5 and 6, wherein the method furthermore comprises the step of repeating steps vii) and viii).
8. The method according to any one of the preceding embodiments, wherein the method furthermore comprises the step of removing wax from the finely divided cereal plant parts or finely divided plant parts after step i) and before step ii).
9. The method according to embodiment 8, wherein said wax is removed by alkaline treatment of the finely divided cereal plant parts or finely divided plant parts.
10. The method according to any one of embodiments 8 to 9, wherein the finely divided cereal plant parts or finely divided plant parts retain at least 40%, such as at least 50% of the lignin after removing wax.
11. The method according to any one of the preceding embodiments wherein the method further comprises a step of extruding the cylinder granulates obtained in step vi).
12. The method according to any one of the preceding embodiments, wherein the method further comprises a step of extruding the cylinder granulates obtained in step vi).
13. The method according to any one of embodiments 5 to 12, wherein the method further comprises a step of extruding the cylinder granulates obtained in step viii).
14. The method according to any one of the preceding embodiments, wherein the cereal plant parts is selected from the group consisting of straw, roots, kernels and husks.
15. The method according to any one of the preceding embodiments, wherein the cereal plant part is selected from the group consisting of malt dust and barley dust.
16. The method according to any one of the preceding embodiments, wherein the cereal is barley.
17. The method according to any one of the preceding embodiments, wherein the finely divided plant parts are prepared by milling using a hammer mill.
18. The method according to any one of the preceding embodiments, wherein the particles with a particle size smaller than 5 μm are removed.
19. The method according to any one of embodiments 17 to 18, wherein milling results in particles, for example cereal particles, wherein at least 90% of the particles have a particle size in the range of 5 to 2000 μm.
20. The method according to any one of the preceding embodiments, wherein at least 40%, such as at least 50% of the particles of the finely divided cereal plant parts, or finely divided plant parts are elongated.
21. The method according to any one of the preceding embodiments, wherein at least 40% of the particles of the finely divided cereal plant parts, or finely divided plant parts have an aspect ratio of at the most 0.6, such as at the most 0.5.
22. The method according to any one of the preceding embodiments, wherein 0-linking is performed by contacting the finely divided cereal plant parts or finely divided plant parts with a compound of the formula I:

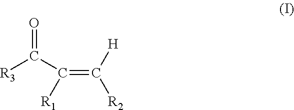

wherein R₁ and R₂ independently are selected from the group consisting of —H, C₁₋₆-alkyl, C₁₋₆-alcohols, C₁₋₆alkoxy, C₁₋₆ ethers, C₂₋₆ alkenyl, halogen and C₁₋₆ alkyl substituted with halogen, and R₃ is selected from the group consisting of halides, C₁₋₆-alkyl halides, C₁₋₆ alkyl sulfonates, halo C₁₋₆-alkylsulfonates, azides, mixed anhydrides, mixed carbonic anhydrides, C₂₋₆-alkenylhalides, arylhalides, and N-methylimidazole.
23. The method according to any one of the preceding embodiments, wherein R₁ is selected from the group consisting of C₁₋₆ alkyl and —H.
24. The method according to any one of the preceding embodiments, wherein R₁ is methyl.
25. The method according to any one of the preceding embodiments, wherein R₂ is selected from the group consisting of C₁₋₆ alkyl and —H.
26. The method according to any one of the preceding embodiments, wherein R₂ is —H.
27. The method according to any one of the preceding embodiments, wherein R₃ is halide.
28. The method according to any one of the preceding embodiments, wherein R₃ is chloride.
29. The method according to any one of embodiments 22 to 28, wherein said finely divided cereal plant part or finely divided plant part is contacted with said compound of formula (I) while said compound of formula (I) is kept in gas phase. 24 to
30. The method according to any one of the preceding embodiments, wherein the composite material comprises in the range of 20 to 70% (w/w) surface modified cereal plant parts or surface modified plant parts, such as in the range of 30 to 50% (w/w) surface modified cereal plant parts or surface modified plant parts.
31. The method according to any one of the preceding embodiments, wherein PMMA have a weight average molecular weight in the range of 50,000 to 200,000, preferably in the range of 70,000 to 150,000, such as in the range of 90,000 to 110,000.
32. The method according to any one of the preceding embodiments, wherein the PMMA has a melt flow index in the range of 0.5 to 20 g, preferably in the range of 7 to 9 g, when determined at 230° C. and 3.8 kg.
33. The method according to any one of the preceding embodiments, wherein PMMA has a density in the range of 1.0 to 1.3 g/cm³, preferably in the range of 1.1 to 1.2 g/cm³
34. The method according to any one of the preceding embodiments, wherein the composite material comprises in the range of 4 to 12% (w/w) PMMA.
35. The method according to any one of the preceding embodiments, wherein the thermoplastic polymer is an thermoplastic polymer having a melt flow index in the range of 0.5 to 3 g/min at 190° C./5 kg.
36. The method according to any one of the preceding embodiments, wherein the thermoplastic polymer is a polyolefin.
37. The method according to any one of the preceding embodiments, wherein the thermoplastic polymer is a petroleum based polymer.
38. The method according to any one of the preceding embodiments, wherein the thermoplastic polymer is selected from the group consisting of polyethylene, ethylene-glycidyl methacrylate copolymer, polystyrene, styrene:butadiene copolymer, poly(l-phenylethene), k-resin and polylactic acid.
39. The method according to any one of the preceding embodiments, wherein the thermoplastic polymer is polyethylene.
40. The method according to any one of the preceding embodiments, wherein the thermoplastic polymer is high-density polyethylene.
41. The method according to embodiment 40, wherein the high-density polyethylene has a density of at least 0.93 g/cm³, for example a density in the range of 0.93 to 0.97 g/cm³.
42. The method according to any one of the preceding embodiments, wherein composite material comprises in the range of 25 to 70%, such as in the range of 30 to 60% (w/w) of polyolefin, e.g. of high-density polyethylene.
43. The method according to any one of the preceding embodiments, wherein the mixture of step v) comprises in the range of 15 to 30% (w/w) surface modified cereal plant parts or surface modified plant parts, in the range of 50 to 70% (w/w) polyolefin and in the range of 5 to 10% (w/w) PMMA.
44. The method according to any one of the preceding embodiments, wherein the step v) of the method furthermore comprises adding a compatibilizer.
45. The method according to embodiment 44, wherein the compatibilizer is a co-polymer polymerized from a mixture of hydrophilic and hydrophobic monomers.
46. The method according to any one of embodiments 44 to 45, wherein the compatilizer is a polymer containing subunits comprising a hydrophilic group selected from the group consisting of a carboxylic group, a carboxylate, a hydroxyl group, sulphonate and an anhydride and containing olefin subunits.
47. The method according to embodiment 44, wherein the compatibilizer is a polyolefin which has been substituted with hydrophilic groups selected from the group consisting of a carboxylic group, a carboxylate, a hydroxyl group, sulphonate and an anhydride and containing olefin subunits.
48. The method according to embodiment 44, wherein the compatibilizer is selected from the group consisting of methacrylated lignin, lignin, polyethylene oxide (PEO), polyvinyl alcohol (PVA), polyethylene polybutylacrylate and ethylene copolymer incorporating a monomer classified as maleic anhydride.
49. The method according to embodiment 44, wherein the compatibilizer is an ethylene copolymer incorporating a monomer classified as maleic anhydride.
50. The method according to any one of the preceding embodiments, wherein the composite material comprises in the range of 1 to 20% (w/w) of a compatibilizer.
51. The method according to any one of the preceding embodiments, wherein the composite material comprises in the range of 1 to 10% (w/w) of ethylene copolymer incorporating a monomer classified as maleic anhydride.
52. The method according to any one of the preceding embodiments, wherein the step v) of the method furthermore comprises adding a plasticizer.
53. The method according to embodiment 52, wherein the plasticizer is a polymer having a melt flow index of at least 4 g/10 min at 190° C./2.16 kg.
54. The method according to any one of embodiments 52 to 53, wherein the plasticizer is a polymer having a density of at the most 0.92 g/cm³.
55. The method according to any one of embodiments 52 to 54, wherein the plasticizer is selected from the group consisting of low molecular weight polypropylene, low-density polyethylene and a co-polymer of propylene and ethylene.
56. The method according to embodiment 52, wherein the plasticizer is low-density polyethylene, wherein the low-density polyethylene has a density of at the most 0.92 g/cm³, such as in the range of 0.89 to 0.92 g/cm³.
57. The method according to any one of the preceding embodiments, wherein the composite material comprises a plasticizer, which is an amorphous metallocene propylene-ethylene-copolymer.
58. The method according to any one of the preceding embodiments, wherein the composite material comprises in the range of 1 to 10%, such as in the range of 1 to 8%, for example in the range of 1 to 5%, such as in the range of 2 to 5% (w/w) of a plasticizer.
59. The method according to any one of the preceding embodiments, wherein extrusion is performed at a temperature of in the range of 160 to 200° C., such as in the range of 170 to 190° C.
60. The method according to any one of the preceding embodiments, wherein the extrusion is performed using a twin-screw extruder.
61. The method according to any one of the preceding embodiments, wherein the composite material comprises in the range of 20 to 70% (w/w) surface modified cereal plant parts or surface modified plant parts.
62. The method according to any one of the preceding embodiments, wherein the composite material comprises in the range of 1 to 20, such as in the range of 2 to 15%, such as in the range of 4 to 10% (w/w) PMMA.
63. The method according to any one of the preceding embodiments, wherein the composite material comprises in the range of 25 to 70%, such as in the range of 30 to 60%, for example in the range of 40 to 50% (w/w) polyolefin.
64. The method according to any one of the preceding embodiments, wherein the method furthermore comprises a step of drying the cylinder granulates.
65. A method of preparing an item of a composite material, said method comprising the step of preparing a composite material by the method according to any one of the preceding embodiments, and injection molding the composite material to form the item.
66. The method according to embodiment 65, wherein the composite material is provided in the form of cylinder granulates.
67. The method according to any one of embodiments 65 to 66, wherein the injection molding is performed at a temperature in the range of 150° C. to 250° C., such as in the range of 160° C. to 230° C., for example in the range of 180° C. to 210° C., such as in the range of 190° C. to 200° C.
68. A composite material prepared by extrusion of a mixture comprising
   a) surface modified cereal plant parts consisting of finely divided cereal plant parts O-lined to one or more groups of the structure

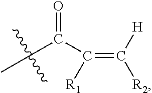

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining;
b) polymethyl methacrylate (PMMA); and
c) thermoplastic polymer.
69. A composite material comprising a mixture of
   a) surface modified cereal plant parts consisting of finely divided cereal plant parts O-lined to one or more groups of the structure

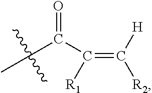

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining;
b) polymethyl methacrylate (PMMA); and
c) thermoplastic material.
70. A composite material prepared by extrusion of a mixture comprising
   a) surface modified plant parts consisting of finely divided plant parts O-linked to one or more groups of the structure

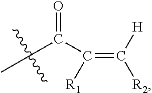

wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining;
b) polymethyl methacrylate (PMMA), and
c) thermoplastic polymer.
71. A composite material comprising a mixture of
   a) surface modified plant parts consisting of finely divided plant parts O-linked to one or more groups of the structure

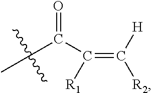

wherein R₁ and R₂ independently are selected from the group consisting of —H, C₁₋₆-alkyl, C₁₋₆-alcohols, C₁₋₆alkoxy, C₁₋₆ ethers, C₂₋₆ alkenyl, halogen and C₁₋₆ alkyl substituted with halogen thereby obtaining;
b) polymethyl methacrylate (PMMA); and
c) thermoplastic material.
72. The composite material according to any one of embodiments 70 to 71, wherein the surface modified cereal plant parts or surface modified plant parts are as defined in or are prepared as defined in any one of embodiments 8 to 29.
73. The composite material according to any one of embodiments 70 to 72, wherein the PMMA is as defined in any one of embodiments 31 to 34.
74. The composite material according to any one of embodiments 70 to 73, wherein the thermoplastic polymer is as defined in any one of embodiments 35 to 43
75. The composite material according to any one of embodiments 70 to 74, wherein the composite material furthermore comprises a compatibilizer.
76. The composite material according to any one of embodiments 70 to 75, wherein the composite material furthermore comprises a compatibilizer, wherein the compatibilizer is as defined in the any one of embodiments 45 to 51.
77. The composite material according to any one of embodiments 70 to 76, wherein the composite material furthermore comprises a plasticizer.
78. The composite material according to any one of embodiments 70 to 77, wherein the composite material furthermore comprises a plasticizer, wherein the plasticizer is as defined in the any one of embodiments 52 to 58.
79. The composite material according to any one of embodiments 70 to 78, wherein the composite material comprises an amount of surface modified cereal plant parts or surface modified plant parts, PMMA, thermoplastic polymer, compatilizer and/or plasticizer as defined in any one of embodiments 31, 34, 42-43, 50-51 and 58-63.
80. The composite material according to any one of embodiments 68 to 79, wherein the composite material has an E-modulus of at least 1500 MPa, such as of at least 2000 MPa, for example of at least 2500 MPa, such as of at least 3000 MPa.
81. The composite material according to any one of embodiments 68 to 80, wherein the composite material has a tensile strength of at least 18 MPa, such as of at least 20 MPa.
82. An item prepared from the composite material according to any one of embodiments 68 to 81.
83. An item comprising or consisting of the composite material according to any one of embodiments 68 to 81.

### EXAMPLES

The invention is further illustrated by the following examples which however should not be construed as limiting for the invention.

### Example 1

In a typical experiment first barley straw is grinded in a two-step process using Hammer mill EU-2000 (from Euro Milling company, Denmark). Product enters into the mill in top, is grinded in grinding chamber and leave through a screen and into the collecting bin. First milling is done with a screen 020 mm (hand filling), and next done with a fine screen (filled with a screw conveyor).

The self-cleaning filter sucks the smallest particles into one side of the collecting bin and the larger particles goes into the other side. A screw conveyor can empty in both directions at the same time, to each outlet of the collecting bin below mill and filter. A hammer mill UNIT can hereby separate particles The elongation was determined using a Morphologi G3SE (Malvern Instruments).

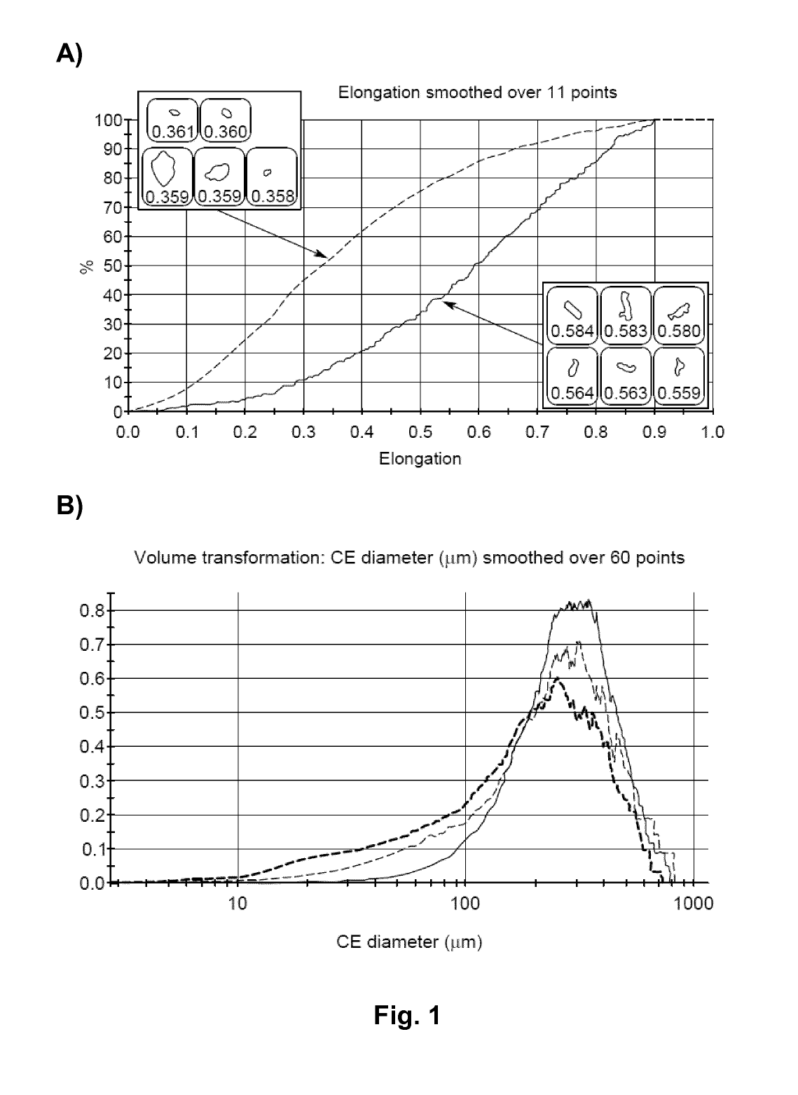

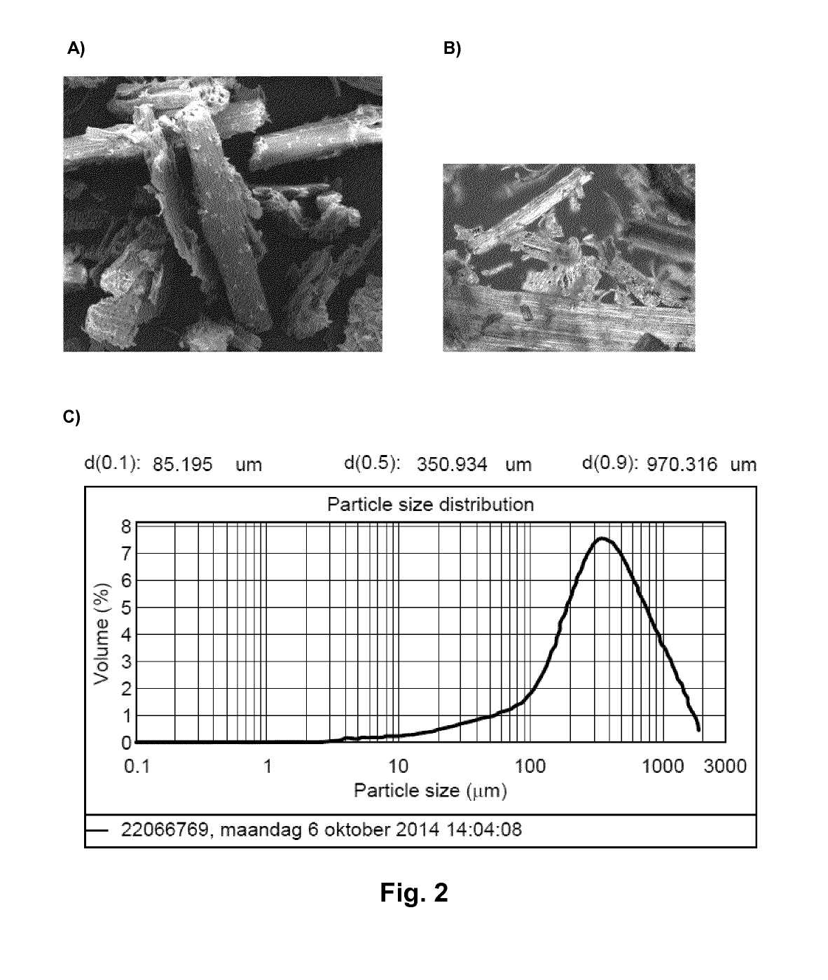

The hammer milled straw samples were dispersed onto a glass plate, imaged, counted and categorized according to their physical properties, and elongation was determined. Elongation is equivalent to 1—aspect ratio, where the aspect ratio is width divided by length. FIG. 1A shows the cumulative distribution of elongation of particles having a circular equivalent diameter (CED) greater than 150 μm (lower curve) and a CED smaller than 150 μm (upper curve). FIG. 1b shows the CED by volume. FIG. 2 shows Scanning Electron Microscopy and Inverted Microscopy of barley straw fibers after hammer milling. Both the elongation analysis and the microscopic analysis clearly shows that the majority of the particles have an elongated shape.

The particle size distribution was also determined. FIG. 2 shows a typical particle size distribution. As can be seen essentially all particles have a particle size in the range of 5 to 2000 μm.

The hammer milled straw is further NaOH treated in order to remove cuticular wax. The NaOH treatment was performed in one of the following ways:

NaoH treatment 1: Samples were weighed into Teflon microwave reaction vessel and 100 ml NaOH solution (0.32%) was added per 10 g sample. The reaction vessel was heated in a Milestone Microwave equipment under constant magnetic stirring at 80° C. for 20 min. The reaction mixture was allowed to cool and transferred into centrifuge tubes and centrifuged. The dark coloured supernatant solution, which is referred to as “black liquor” was discarded and the solid product was washed with water (sonicated) 6 times. The product was lyophilized to obtain dry powder. The dried straw generally has a mass of 71% of the starting mass of the straw.

NaOH treatment 2: The same experiment was scaled up to 2.5 kg scale in pilot brewery reactor using convention heating procedure. The 0.32% NaOH straw mixture was kept at 80° C. for 60 min. with stirring and allowed to cool down to room temperature. The cold sample was filtered out and washed with water until the washing was free of yellow color. The product was air dried and homogenized in a laboratory blender and further dried under vacuum at 95° C. 3 hrs before use.

The NaOH treatment is a mild treatment to keep the structure of straw. The treatment may remove some lignin and other components in addition to cuticular wax, however, a significant proportion of the lignin is still retained in the straw. Thus, typically around 40% of the lignin of the straw is removed by the NaOH treatment. The remainder of the lignin is contained in the black liquor and may be purified from this.

The hammer milled and NaOH treated straw is then subjected to gas phase surface modification reaction (Methacryloyl chloride) in 400 to 500 g batches. The surface modification reaction is carried out in a custom made loop reactor, the milled, NaOH treated and dried straw was first added into the bottom of conical space and the reactor was evacuated and purged with dry nitrogen. The heating was started with slow flow using a centrifugal pump inbuilt. The loop reactor heated to 85 to 90° C. in 1 hour time and then injected Trimethylamine (7.5 ml in small portions in 15 minutes followed by addition of Metharyloyl chloride 3.5 ml in small portions in 15 minutes. The column was maintained at 90° C. for 1 hr and heating switched off. The air circulation was continued and after cooling the product straw taken out of the reactor and directly used in the next step.

The barley straw, which has been hammer milled, NaOH treated and gas phase methacrylated as described above is referred to as “Meth Straw” herein.

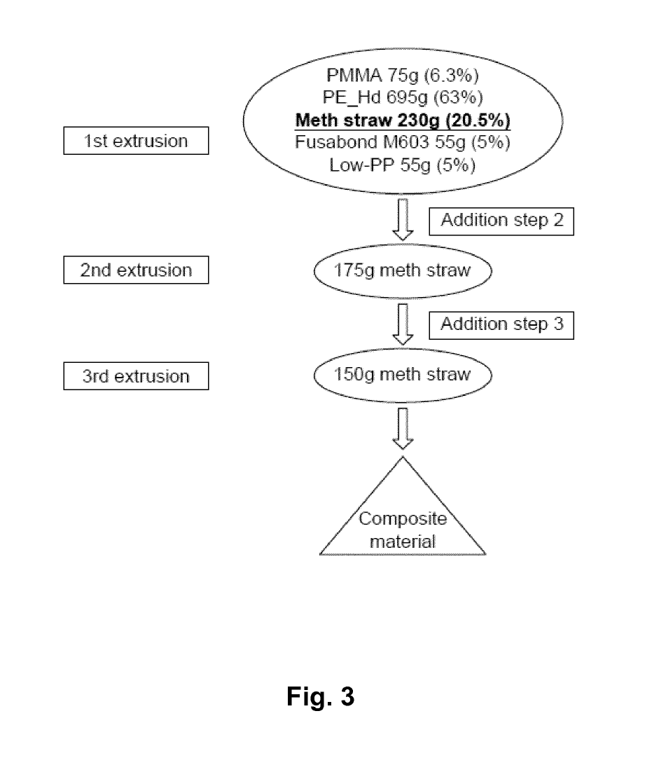

The Meth Straw 230 g (20.5%) and the following polymers: high-density polyethylene 695 g (63%), Poly methyl methacrylate (PMMA) 75 g molecular weight Mw 100000 (6.3%), Fusabond M603 55 g (5%) and Low molecular weight Polypropylene 55 g (5%) were mixed manually in a trough and dried over night under vacuum at 100° C. The mixture was cooled and fed to a Lab extruder (20 mm, 30 L/D Bench Top Laboratory single screw Extruder type LBE20-30/C) and extruded at 180° C. The polymer composite strings which were extruded out were cooled in a water bath and passed through a cutter. The speed of the extruder varied between 30-40 rpm at torque 50. The straw composite pellets (cylinder granulates) were collected and dried in a vacuum oven 4 hr and mixed with dry Meth Straw 175 g, the extrusion process repeated under same conditions and product dried under vacuum for 4 hr and further mixed with additional 150 g of dry Meth Straw and extruded. The final product will contain 41% dried Meth Straw and this was further dried and extruded up to 3 more times to ensure uniform mixing. An overview of the process is provided in FIG. 3.

The straw polymer pellets were dried thoroughly under 3 hr vacuum at 100° C. before injection molding.

### Example 2

Four different samples (396, 530, 505 and 501) materials were prepared essentially as described in Example 1, except that the materials had the compositions indicated below. Meth Straw was prepared as described in Example 1, however, extrusion was prepared using the ingredients described below. Extrusion was performed 3×, wherein approx. ½ of the methacrylated straw was mixed with the other ingredients prior to the first extrusion, approx. ¼ of the methacrylated straw was added prior to the second extrusion, and approx. ¼ of the methacrylated straw was added prior to the third extrusion.

Samples 396; 530 and 505 contains the same ingredients, but were made using two different straw batches in the optimized milling process. They contain the following composition:

PMMA (5%)
PE_HD (47.%)
Meth Straw Batch 5/6 (41.%)
Fusabond (3.5%)
Low-PP (3.5%)

Sample 531 has the following composition:

PMMA (5%)
PE_HD (34.%)
PE_GMA(13%)
Meth Straw Batch 5 (41.%)
Fusabond (3.5%)
Low-PP (3.5%)

The PE GMA is Aldrich 430862 CAS No. 26061-90-5.

The PE HD was BB2581 from Borealis. BB2581 is a high-density polyethylene intended for blow molding products.

Injection molding of the samples for tensile strength measurements were done at 190° C. to 200° C. Special molds were constructed for making dumb-bell shaped test specimens for tensile strength measurements according to ISO/DIS 527 Type 2. Length 115 mm; width 6 mm; thickness 2.2-2.7 mm. Tensile strength was measured at Intertek Polychemlab BV according to standard ISO 527/3 type 2 specifications. The experiments for E-modulus were run with a speed of 2 mm/min at 23° C. The results are shown in Table 1

TABLE 1
Mechanical properties of Straw polymer.

| | | | | |
|---|---|---|---|---|
| Sample | 396 | 530 | 531 | 505 |

Tensile ISO 527/3 type 2 % Sample each
T = 23° C. 2 mm/min

| | | | | | |
|---|---|---|---|---|---|
| Tensile strength | Mpa | 32.9 | 30.3 | 30.0 | ND |
| Tensile strength | Mpa | 0.5 | 0.3 | 0.6 | ND |
| S.D. | | | | | |
| Stress at | Mpa | 32.6 | 29.6 | 29.3 | 30.4 |
| break | | | | | |
| Stress at | Mpa | 0.6 | 0.5 | 1.0 | 0.8 |
| break S.D. | | | | | |
| E-Modulus | Mpa | 3446.5 | 3255.7 | 3269.5 | 3092 |
| E-Modulus | Mpa | 84.5 | 52.4 | 115 | 64.1 |
| S.D. | | | | | |
| Elongation | % | 2.4 | 2.3 | 2.3 | 2.39 |
| at break | | | | | |
| Elongation | % | 0.2 | 0.1 | 0.1 | 0.15 |
| at break | | | | | |
| S.D. | | | | | |
| Density | | 1.1 | 1.05 | 1.06 | 1.08 |
| (g/ml) | | | | | |

The High-Density PE used (BB2581 from Borealis) had the following tensile strength:

| | |
|---|---|
| Tensile Modulus | 1300 MPa |
| Tensile Strength | 29 MPa |
| MFI at 190° C. 5 Kg | 0.3 g/10 min |
| Density | 958 Kg/m³ |

Tensile strength is in par with the tensile strength of polyethylene (PE) but the modulus is three times higher.

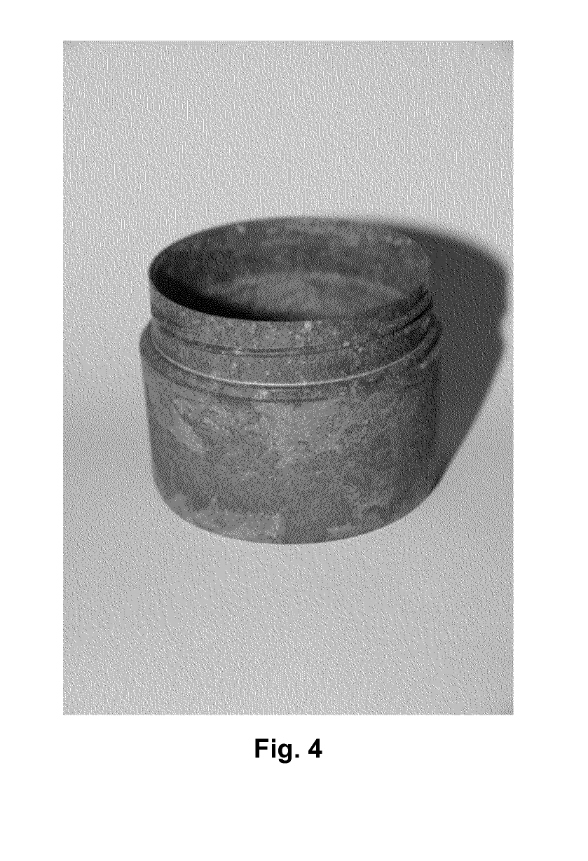

In addition to samples for tensile strength measurements also other objects were prepared. For example, small cups were injection molded (see FIG. 4). As can be seen even fine structures, such as sharp edges can be prepared with the material.

### Example 3

Differential scanning calorimetry (DSC) experiments were performed to test the stability of the composite material according to the invention. Materials were stable after several melting cycles are in general useful for injection molding.

All DSC measurements were made on single samples with a Mettler Toledo Thermal Analyzer with a DSC1attachment.

For analysis, Small portions of sample around 5-mg accurately weighed were used and the forages were heated in a static air atmosphere at a rate of 10° C. min-1. Calibration of the instrument was carried out according to standard instructions by measuring the temperature and enthalpy of fusion of pure samples of ice, indium, tin and zinc.

Two straw polymer composites, samples 530 and 531 containing HDPE and surface modified Straw (41% by weight) were tested. The samples were prepared essentially as described in Example 1, and the contents of the samples are described in Example 2. Samples 530 and 531 were heated from 25 to 190° C. three times; there is no change in the heating pattern showing the stability of the material for recycling. Both the polymer has a melting peak in the 142-146° C. range.

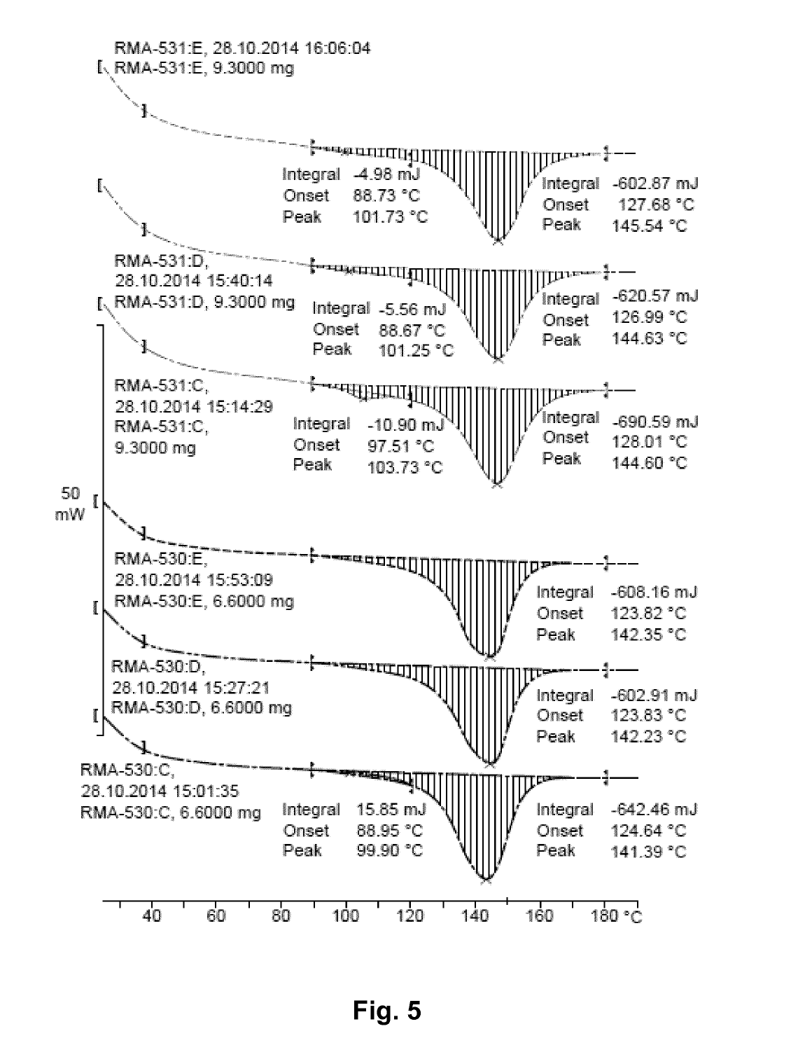

Thus, the differential scanning calorimetry (DSC) experiment show the polymer is stable up to 240° C. and can be melted and recycled without loss of mechanical or chemical structure. The results are shown in FIG. 5.

### Example 4

Thermal insulation of the material was tested and found in par with PE. A sample was prepared by injection molding the material prepared as described in Example 1 into a disc with a diameter of 50.8 mm and thickness 2.75 mm. This sample is referred to as RMA0535D 12-02. The resistance to thermal transmission was determined using the ASTM E-1530-11 standard.

### Description of Sample

TABLE 1
sample discription

| | Intertek |
|---|---|
| | identification |
| Sample description | number |
| Disc with diameter 50.8 mm, and thickness 2.75 mm | 22130717 |
| Customer identification: RMA0535D 12-02 | |

### Method(s) Applied

Resistance to thermal transmission of materials by the guarded heat flow meter technique according to ASTM E-1530-11.

Equipment: Anter Unitherm Model 2022.

Target test temperature: 30° C.

Orientation of transmission: axially through specimen thickness.

### Results

| | | | | Thermal |
|---|---|---|---|---|
| | Sample | Thermal resistance | | conductivity |
| Sample | thickness Mm | m² · K · W⁻¹ | ft² · F · hr · BTU⁻¹ | W · m⁻¹ · K⁻¹ |
| RMA0535D 12-02 | 2.75 | 0.0070 | 0.040 | 0.39 |

### Example 5

The melt flow index and the water uptake of materials prepared as described in Example 1 were determined.

Furthermore, additional materials were prepared essentially as described in Example 1. The final content of these materials are provided in Table 2. The materials were prepared essentially as described in Example 1, except that the indicated amounts of polyolefins, PMMA and surface modified cereal plant parts were used. Thus, in some of the materials, instead of HDPE other polyolefins are used, such as Polystryene-Polybutadine or Polylactic acid or other petroleum based polymers as indicated. In some materials methacrylated Barley straw prepared as described in Example 1 is used, whereas in other materials this has been substituted with methacrylated Malt dust, Root spikes and barley dust. Malt dust, Root spikes and barley dust were methacrylated in the same manner as milled barley straw as described in Example 1. Furthermore, lignin has been recovered from the black liquor (obtained as described in Example 1) and modified by gas phase methacylation in the same manner as the barley straw (see Example 1). The methacrylated lignin was added to the composite preparation before extrusion (Meth Lig) and yielded composites with the properties shown in in table 2 below. The methacrylated barley straw, malt dust, root spikes, barley dust or lignin was step-wise as described in Example 1, i.e. approx. ½ was mixed with the other ingredients prior to the first extrusion, approx. ¼ was added prior to the second extrusion, and approx. ¼ was added prior to the third extrusion. Melt flow index of various materials according to the invention were measured at 190° C. 7 kg weight, using a capillary with a diameter of 2.095 mm (Part no 338/10 Davenport)

It should be noted that materials prepared by co-polymerization of methacrylated milled plant fibers with monomer e.g. as described in international patent application WO2010/06932 results in a material which cannot be injection molded, and which has a melt flow index of 0 g.

Water swelling experiments of the different materials were done at 20° C. for 24 hr and the samples show very low water swelling. Water Swelling experiments were carried out using the same injection molded dumb-bell shaped test specimens used for tensile strength measurement described in Example 2. The test specimens were stored under ambient conditions. The samples were accurately weighted and swelled in distilled water at room temperature for 24 hrs. The samples were taken out and wiped with clean towel and surface dried with hot air blower 1 min. The sample was weight and difference in weigh divide by final weight times 100 gave to percentage swelling. The results are shows in table 2 and is compared with HDPE. It can be seen the values are approaching 0.5% by carefully tailor making the straw polymer composite.

The melt flow index, the water uptake and the density of materials prepared as described in Example, optionally with the indicated changes are shown in Table 2.

TABLE 2

| | | Melt Flow | % H₂0 | |
|---|---|---|---|---|
| Polymer Formulation for Extrusion | Ref. No. | Index | uptake | Density (g/ml) |
| 41% Meth-Straw (EM-5), 47% PE- | 396 | 1.0 g | 0.56% | 1.198 |
| HD, 5% PMMA | | | | |
| 41% Meth-Straw (EM-5) 47% PE- | AB530 | 1.0 g | 0.54% | 1.05 |
| HD, 5% PMMA | | | | |
| 41% Met-Straw (EM-6) 34% PE- | AB516 | ND | 4.70% | 1.057 |
| HD, 5% PMMA | | | | |
| 13% POE 8 Million MolWt. Carbowax | | | | |
| 41% Met-Straw (EM-6) 34% PE- | AB518 | ND | 1.33% | 1.076 |
| HD, 5% PMMA | | | | |
| 13% PVA 146-186,000 mol wt Adrich | | | | |
| 363065 | | | | |
| 41% Meth-Straw (EM-5)HDPE | AB531 | 0.27 g | 0.79% | 1.06 |
| PMMA | | | | |
| 13% PE-GDM Adrich 430862 | | | | |
| 41% Meth-Straw (EM-5) 44% PE- | AB501A2 | 1.35 g | 0.64% | 1.08 |
| HD, 5% PMMA | | | | |
| 3% Meth_Lignin | | | | |
| HDPE Pure | | 2.5 g | 0.12% | 0.958 |
| 41% Meth-MaltDust, 47% PE-HD, 5% | AB504 | 2.3 g | 0.66% | 1.085 |
| PMMA | | | | |
| 41% MetRadSpik, 47% PE-HD, 5% | AB510 | 2.45 g | 1.04% | 1.024 |
| PMMA | | | | |
| 41% MetBygsta, 47% PE-HD, 5% | AB511 | 2.08 g | 0.67% | 1.034 |
| PMMA | | | | |
| 41% Meth-Straw (EM-3), 41% PE- | 4395A | 1.75 g | 1.04% | 1.23 |
| HD, 5% PMMA | | | | |
| 6% Meth_Lignin | | | | |
| 20% Meth-Straw (EM-3) 55% PE- | 4395A1 | 2.5 g | 1.23% | 1.22 |
| HD, 9% PMMA | | | | |
| 6% Meth_Lignin, 5% PPLow, 5% | | | | |
| FusabondM603 | | | | |
| 41% Meth-Straw (EM-6), 47% PE- | AB517 | 1.5 g | 0.67% | 1.04 |
| HD, 5% PMMA | | | | |
| 41% Meth-Straw (EM-6), 47% PE- | AB505 | 1.6 g | 0.62% | 1.08 |
| HD, 5% PMMA | | | | |
| 41% Meth-Straw (EM-6) 42% PE-HD, | AB506 | 1.5 | 0.76% | 1.1 |
| 10% PMMA (25K) | | | | |
| 41% Meth-Straw (EM-6) 47% PE-HD, | AB539 | 1.65 g | 0.37% | 1.028 |
| 5% PMMA 5.5 Kg for CUP | | | | |
| 42% MethStrawEuroRun1, 37.2% | AA- | 8.7 g | 2.4% | 1.12 |
| PS-PBD 6.2% PE_PBAr, 9.3% | 4377A1 | | | |
| PPlow, 5.3% FB | | | | |
| 41% MethStrawEuroRun1, 42% PS- | AA- | 6.5 g | 2.2% | 1.13 |
| PBD, 3.5% PMMA, 9.5% PPlow, 4% | 4377A2 | | | |
| FB | | | | |
| 41% MethStrawEuro Run1, 47% | AA- | 3.3 g | 1.8% | 1.1 |
| PE_BAr, 5% PMMA | 4377A3 | | | |
| 40.6% MethStrawEuro Run1, 47% | AA- | 2.2 g | 1.8% | 1.13 |
| PS-PBD, 5% PMMA, 3.7% PPlow, | 4377A4 | | | |
| 3.7% FB | | | | |
| 42% MethStrawEuroRun1, 12.4% | AA- | 8.44 g | 1.84% | 1.12 |
| PE_PBAr, 31% PS-PBE, 9.2% | 4377A5 | | | |
| PPlow, 5.4% FB | | | | |

All the samples described in Table 2 furthermore contained 3.5% Fusabond M603 (Dupont), and 3.5% Licocene PP 1502 (Clariant), except for samples 4395A1, AA-4377A1, AA-4377A2, AA-4377A4 and AA-4377A5. All % in table 2 are provided as w/w %.

The following abbreviations are used in Table 2 and also elsewhere in the examples: Meth-Straw: Methacrylated straw prepared as described in Example 1 PE-HD or HDPE: high-density polyethylene BB2581 from Borealis PMMA: polymethyl methacrylate, Altuglas® V 920 PMMA from Arkema

POE: Polymer of ethylene oxide having average molecular weight 8 mio.-cat. No 372838 Aldrich

PVA: Poly(vinyl alcohol) having an average molecular weight of 146-186,000 obtained from Adrich, Cat. No. 363065

PS-PBD: polystyrene poly butadiene co-polymer, K RESIN KR03.

PE_PBAr: Polyethylene Polybutylacrylate, Lucof in 1400HN,

FB: Fusabond M602 (Dupont),

PE-GDM was Polyethylene glycol dimethacrylate obtained from Aldrich, Cat. No. 430862

Meth_Lignin: lignin methacrylated by gas phase methacrylation as described in Example 1 Meth-Maltdust: Maltdust methacrylated by gas phase methacrylation as described in Example 1

MethR\dot{a}dspik: barley root spikes methacrylated by gas phase methacrylation as described in Example 1

MethBygst\dot{a}: Barley dust methacrylated by gas phase methacrylation as described in Example 1

Low PP: Licocene PP 1502 (Clariant)

### Example 6

A composite material was prepared essentially as described in Example 1 with the following amendments;

The content of the composite material was PMMA 7%, PE-HD 62.5% MethStBa6 20.5% Fusabond 5% and Low-PP 5%.

MethStBa6 was methacrylated barley straw prepared as described in Example 1. PMMA, PE-HD, Fusabond and Low-PP were as described in Example 5.

All the components of the material were mixed and subjected to extrusion using a single screw extruder. The resulting material is shown in FIG. 6A. The material obtained was subjected to a second round of extrusion using a twin screw extruder. The resulting material is shown in FIG. 6B.

The properties of the material obtained after the second extrusion was determined using the ISO methods indicated in Table 3, and the results are given in the same table. Compared to the results shown in Example 2, the Test results show that a lower percentage of methacrylated straw results in a lower strength and modulus, whereas a higher % of methacrylated straw show better tensile strength and modules. This indicates that methacrylated straw is compatible with the polymer matrix and there by enhances the physical properties of final product.

TABLE 3
Mechanical properties of (20%) Straw polymer

| | | | | |
|---|---|---|---|---|
| | | | | Standard |
| Temperature | Method | Unit | Value | deviation |

Mechanical properties

| | | | | | |
|---|---|---|---|---|---|
| E-Modulus | 23° C. | ISO 527-2 | MPa | 1639 | 70 |
| | 60° C. | ISO 527-2 | MPa | 714 | 68 |
| Flexural Modulus | 23° C. | ISO 178 | MPa | 1547 | 16 |
| Stress at Yield | −40° C. | ISO 527-2 | MPa | N/A | N/A |
| | 23° C. | ISO 527-2 | MPa | 21.3 | 0.2 |
| | 60° C. | ISO 527-2 | MPa | 11.7 | 0.1 |
| Stress at Break | −40° C. | ISO 527-2 | MPa | 43.5 | 2.8 |
| | 23° C. | ISO 527-2 | MPa | 19.5 | 0.7 |
| | 60° C. | ISO 527-2 | MPa | 9.7 | 0.4 |
| Strain At Yield | −40° C. | ISO 527-2 | % | N/A | N/A |
| | 23° C. | ISO 527-2 | % | 4.6 | 0.1 |
| | 60° C. | ISO 527-2 | % | 7.1 | 0.2 |
| Strain at Break | −40° C. | ISO 527-2 | % | 3.0 | 0.2 |
| | 23° C. | ISO 527-2 | % | 7.5 | 1.3 |
| | 60° C. | ISO 527-2 | % | 17.3 | 3.8 |
| Flexural Stress at Yield | 23° C. | ISO 178 | MPa | 29.7 | 0.5 |
| Flexural Strain at Yield | 23° C. | ISO 178 | % | 6.4 | 0.1 |
| Impact resistance, | 23° C. | ISO 179-1 | kJ/m² | 4.2 | <0.1 |
| Charpy | | | | | |

Other Physical properties

| | | | | | |
|---|---|---|---|---|---|
| apparent Density, | 23° C. | ISO 1183-2, | Kg/m³ | 0.92-0.95 | N/A |
| compound | | Non-accredited | | | |
| Density, compound | 19° C. | He-gas | Kg/m³ | 1061.4 | 0.7 |
| | | Pycnometer | | | |
| apparent Density, | 23° C. | Weight/Volume | Kg/m³ | 1005 | N/A |
| injection mould | | | | | |

1. A method of preparing a composite material, said method comprising the steps of
Providing finely divided plant parts
O-linking the plant parts with one or more groups of the structure 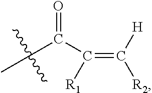
wherein R₁ and R₂ independently are selected from the group consisting of —H, C₁₋₆-alkyl, C₁₋₆-alcohols, C₁₋₆ alkoxy, C₁₋₆ ethers, C₂₋₆ alkenyl, halogen and C₁₋₆ alkyl substituted with halogen thereby obtaining surface modified plant parts;
Providing polymethyl methacrylate (PMMA)
Providing a thermoplastic polymer
Mixing surface modified plant parts, PMMA and thermoplastic polymer;
Extruding the mixture to form composite strings, which optionally are divided into cylinder granulates
thereby preparing a composite material.

2. The method according to claim 1, wherein the method further comprises the steps of
Mixing the cylinder granuates with surface modified plant parts and
Extruding the mixture formed in step vii) to form composite strings, which are divided into cylinder granulates;
and optionally the step of repeating said steps.

3. The method according to any one of the preceding claims, wherein the method further comprises a step of extruding the cylinder granulates.

4. The method according to any one of the preceding claims, wherein the method furthermore comprises the step of removing wax from the finely divided plant parts after step i) and before step ii), wherein said wax is removed by alkaline treatment of the finely divided plant parts.

5. The method according to any one of the preceding claims, wherein the plant parts are barley straw.

6. The method according to any one of the preceding claims, wherein at least 40%, such as at least 50% of the particles of the finely divided plant parts are elongated.

7. The method according to any one of the preceding claims, wherein 0-linking is performed by contacting the finely divided plant parts with a compound of the formula I: 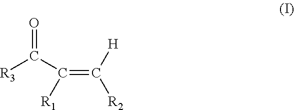
wherein R₁ and R₂ independently are selected from the group consisting of —H, C₁₋₆-alkyl, C₁₋₆-alcohols, C₁₋₆alkoxy, C₁₋₆ ethers, C₂₋₆ alkenyl, halogen and C₁₋₆ alkyl substituted with halogen, and R₃ is selected from the group consisting of halides, C₁₋₆-alkyl halides, C₁₋₆ alkyl sulfonates, halo C₁₋₆-alkylsulfonates, azides, mixed anhydrides, mixed carbonic anhydrides, C₂₋₆-alkenylhalides, arylhalides, and N-methylimidazole, while said compound of formula (I) is kept in gas phase.

8. The method according to any one of the preceding claims, wherein the thermoplastic polymer is a thermoplastic polymer having a melt flow index in the range of 0.5 to 3 g/min at 190° C./5 kg.

9. The method according to any one of the preceding claims, wherein the thermoplastic polymer is a polyolefin, preferably high-density polyethylene.

10. The method according to any one of the preceding claims, wherein the step v) of the method furthermore comprises adding a compatibilizer.

11. The method according to claim 10, wherein the compatibilizer is selected from the group consisting of methacrylated lignin, lignin, polyethylene oxide (PEO), polyvinyl alcohol (PVA), polyethylene polybutylacrylate and ethylene copolymer incorporating a monomer classified as maleic anhydride.

12. The method according to any one of the preceding claims, wherein the step v) of the method furthermore comprises adding a plasticizer.

13. The method according to any one of the preceding claims, wherein extrusion is performed at a temperature of in the range of 160 to 200° C., such as in the range of 170 to 190° C.

14. The method according to any one of the preceding claims, wherein the plant parts are plant parts of a cereal plant (cereal plant parts).

15. A method of preparing an item of a composite material, said method comprising the step of preparing a composite material by the method according to any one of the preceding claims, and injection molding the composite material to form the item.

16. A composite material prepared by extrusion of a mixture comprising
a) surface modified plant parts consisting of finely divided plant parts O-lined to one or more groups of the structure 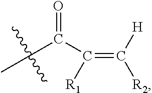
wherein R₁ and R₂ independently are selected from the group consisting of —H, C₁₋₆-alkyl, C₁₋₆-alcohols, C₁₋₆alkoxy, C₁₋₆ ethers, C₂₋₆ alkenyl, halogen and C₁₋₆ alkyl substituted with halogen thereby obtaining;
b) polymethyl methacrylate (PMMA)
c) thermoplastic polymer.

17. The material according to claim 15, wherein the plant parts are cereal plant parts.

18. An item prepared from the composite material according to any one of claims 15 to 16.
